(19) United States
(12) Patent Application Publication
(10) Pub. No.: US 2020/0216225 A1
(43) Pub. Date: Jul. 9, 2020

(54) RECLOSABLE LAP SEAL PACKAGES

(71) Applicants: Dow Global Technologies LLC, Midland, MI (US); Rohm and Haas Company, Collegeville, PA (US)

(72) Inventors: Vivek Kalihari, Freeport, TX (US); Chuan-Yar Lai, Houston, TX (US); Erica Spiekermann, Freeport, TX (US); Cristina Serrat, Freeport, TX (US); Marc S. Black, Midland, MI (US); Daniel S. Woodman, Midland, MI (US); Chad V. Schuette, Midland, MI (US); Piyush Soni, Midland, MI (US); Xiaosong Wu, Freeport, TX (US); Daniel W. Himmelberger, Collegeville, PA (US); Vinita Yadav, Collegeville, PA (US); Bruno Rufato Pereira, Houston, TX (US)

(73) Assignees: Dow Global Technologies LLC, Midland, MI (US); Rohm and Haas Company, Collegeville, PA (US)

(21) Appl. No.: 16/640,537

(22) PCT Filed: Sep. 21, 2018
(86) PCT No.: PCT/US18/52108

§ 371 Date: Feb. 20, 2020

Related U.S. Application Data
(60) Provisional application No. 62/562,064, filed on Sep. 22, 2017.

(51) Int. Cl. B65D 33/20; B32B 27/08; B32B 27/32

(52) U.S. Cl. CPC B65D 33/20; B32B 2405/00; B32B 27/32; B32B 27/08

(57) ABSTRACT

The present disclosure is directed to a reclosable package comprises a front wall, a rear wall, and an upper closure. At the upper closure, at least a portion of a surface of the rear wall is sealed to an exterior surface of the front wall at a first adhesion strength. According to embodiments, the application of a force greater than the first adhesion strength to the rear wall in a direction away from the front wall is operable to separate the portion of a surface of the rear wall from the exterior surface of the front wall. After, the return of the portion of the surface of the rear wall and an application of a force on the rear wall in the direction of the front wall is operable to reseal the portion of the interior surface of the rear wall to the exterior surface of the front wall.

### CROSS-REFERENCE TO RELATED APPLICATIONS

This application claims priority to U.S. Provisional Patent Application No. 62/562,064, filed Sep. 22, 2017, the contents of which are hereby incorporated by reference in their entirety.

### BACKGROUND

### Technical Field

This disclosure relates to packaging articles. More specifically, this disclosure relates to resealable packaging articles and resealable packaging articles including adhesives.

### Background

Convenience is a growing trend in the food packaging industry, with consumers looking for packaging that can be easily handled and used. Reclosability in packaging not only offers consumer convenience, but also provides longer shelf life of the packed product without the need to transfer contents into separate reclose packages, such as zippered plastic bags or multi-piece rigid containers, for example. Conventional reclose systems are limited in availability and have shortcomings such as additional fabrication steps or poor processability. Conventional reclose packages are usually coated water based acrylics and require lamination, die-cutting, or other secondary processing steps. Hot melt adhesives based on styrenic block copolymers (SBC) eliminate some of the processing steps needed for coated adhesives, but are difficult to process and and may impart an odor and/or taste to the package.

### SUMMARY

Accordingly, an ongoing need exists for reclosable packages—that is, packages with reclose and reopen functionality—with improved processability and designs that enable streamlined and efficient manufacture. A need further exists for packages with reclosable lap seals. A need further exists for food packages including adhesive compositions that enable reclose and reopen functionality.

At least one or more of these needs are met by embodiments of the reclosable packages of the present disclosure. The packages of the present disclosure are structurally designed to have reclosable seals that can be integrated into the packaging. The reclosable seals involved in packages of the present disclosure are versatile and can be modified to fit a variety of packaging sizes, shapes, and types. The reclosable seals may also include a multilayer film and the walls of the package may be integrated into the multilayer film. The package designs additionally may allow for the integration of adhesive compositions suitable for use in food packages into the reclosable seal, in some embodiments.

According to one or more embodiments, a reclosable package comprises a front wall, a rear wall, and an upper closure. At the upper closure, at least a portion of a surface of the rear wall is sealed to an exterior surface of the front wall at a first adhesion strength. According to embodiments, the application of a force greater than the first adhesion strength to the rear wall in a direction away from the front wall is operable to separate the portion of a surface of the rear wall from the exterior surface of the front wall. This separation may expose a reclose region on the exterior surface of the front wall. In one or more embodiments, the return of the portion of the surface of the rear wall into contact with the reclose region and an application of a force on the rear wall in the direction of the reclose region is operable to reseal the portion of the interior surface of the rear wall to the exterior surface of the front wall at a second adhesion strength.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

### BRIEF DESCRIPTION OF THE DRAWINGS

FIG. 1A schematically depicts a front perspective view of a closed reclosable package, according to one or more embodiments of the present disclosure;

FIG. 1B schematically depicts a front perspective view of an open reclosable package, according to one or more embodiments of the present disclosure;

FIG. 2 schematically depicts a cross-sectional view of a reclose film that includes three layers, according to one or more embodiments of the present disclosure;

FIG. 3 schematically depicts a cross-sectional view of another reclose film that includes 4 layers, according to one or more embodiments of the present disclosure;

FIG. 4A schematically depicts a cross-sectional view of the reclose film of FIG. 2 adhered to a substrate, according to one or more embodiments of the present disclosure;

FIG. 4B schematically depicts a cross-sectional view of the reclose film of FIG. 4A in which the reclose film has been initially opened to activate the reclose functionality of the reclose film, according to one or more embodiments of the present disclosure;

FIG. 4C schematically depicts a cross-sectional view of the reclose film of FIG. 4B in which the reclose film has been reclosed following initial opening of the reclose film, according to one or more embodiments of the present disclosure;

FIG. 4D schematically depicts a cross-sectional view of the reclose film of FIG. 4C in which the reclose film has been reopened after being reclosed, according to one or more embodiments of the present disclosure;

FIG. 5A schematically depicts a cross-sectional view of the reclose film of FIG. 4A taken along reference line 5A-5A in FIG. 4A, according to one or more embodiments of the present disclosure;

FIG. 5B schematically depicts a cross-sectional view of the reclose film of FIG. 5A in which the reclose film has been initially opened to activate the reclose functionality of the reclose film, according to one or more embodiments of the present disclosure.

The embodiments set forth in the drawings are illustrative in nature and not intended to be limiting to the claims. Moreover, individual features of the drawings will be more fully apparent and understood in view of the detailed description.

### DETAILED DESCRIPTION

Embodiments of the present disclosure are directed to reclosable packages. Reclosable packages of the present disclosure comprise a front wall, a rear wall, and an upper closure. The upper closure comprises at least a portion of a surface of the rear wall sealed to an exterior surface of the front wall at a first adhesion strength. According to embodiments, the application of a force greater than the first adhesion strength to the rear wall in a direction away from the front wall is operable to separate the portion of a surface of the rear wall from the exterior surface of the front wall. This separation may expose a reclose region on the exterior surface of the front wall. In one or more embodiments, the return of the portion of the surface of the rear wall into contact with the reclose region and an application of a force on the rear wall in the direction of the reclose region is operable to reseal the portion of the interior surface of the rear wall to the exterior surface of the front wall at a second adhesion strength.

As used herein, a “seal” refers to a closure of two or more items in contact, direct or indirect, that is tight enough to prevent passage of unwanted materials through the point or surface of contact. A seal may be mechanical or chemical in nature. For example, a mechanical seal might consist of two rigid surfaces that interlocked in such a fashion as to prevent movement of the surfaces and movement between the surfaces, such as zippers, snap lids, or similar devices. Examples of chemical seals include solders, welds, adhesives, or similar substances that use a temperature, pressure, or a combination thereof to introduce a chemical composition that prevents movement of two or more items. The seal encompasses the items in contact, the surface or point of contact, and any other materials that might be at the surface or point of contact. So, for example, the seal of a solder between two pieces of metal includes the joint or region where the two pieces of metal are in direct or indirect contact and the filler metal in the joint. The tightness of a seal may vary; hermetic seals, water-tight seals, liquid-tight seals, air-tight seals, wet gas-tight seals, or dry gas-tight seals are contemplated.

Similarly, as used in this disclosure, two or more items can be said to be “sealed” together when a surface of contact, direct or indirect, between the items is part of a seal. In some instances, the seal may be a result of the chemical or mechanical interactions between the items at the surface. For example, meant to be illustrative and not limiting, if two objects are in adhering contact, and there is a seal at the surface of contact, the two objects can be said to be sealed together. As used herein, “lap seal” refers to a seal in a packaging article where one surface of the package is folded over another surface of the package before the two surfaces are sealed. In the art, some lap seals may also be referred to as fold-over seals, overlap seals, fin seals, tab seals, or similar analogous terms.

As used herein, the term “contact” can mean either direct contact or indirect contact. Direct contact refers to contact in the absence of intervening material and indirect contact refers to contact through one or more intervening materials. Items in direct contact touch each other. Items in indirect contact do not touch each other, but do touch an intervening material or series of intervening materials, where the intervening material or at least one of the series of intervening materials touches the other. Items in contact may be rigidly or non-rigidly joined. Contacting refers to placing two items in direct or indirect contact. Items in direct contact may be said to directly contact each other. Items in indirect contact may be said to indirectly contact each other. It should be understood that, in some embodiments, when two items are “in contact” with one another, they are in direct contact with one another.

The term “polymer” refers to a polymeric compound prepared by polymerizing monomers, whether of the same or a different type. The generic term polymer thus embraces the term “homopolymer” usually employed to refer to polymers prepared from only one type of monomer as well as “copolymer” which refers to polymers prepared from two or more different monomers. The term “block copolymer” refers to a polymer comprising two or more chemically distinct regions or segments (referred to as “blocks”). In some embodiments, these blocks may be joined in a linear manner, that is, a polymer comprising chemically differentiated units which are joined end-to-end. A “random copolymer” as used herein comprises two or more polymers where each polymer may comprise a single unit or a plurality of successive repeat units along the copolymer chain back bone. Even though some of the units along the copolymer chain backbone exist as single units, these are referred to as polymers herein.

“Polyethylene” or “ethylene-based polymer” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). As used herein, “ethylene/α-olefin random copolymer” is a random copolymer comprising greater than 50% by weight of units derived from ethylene monomer

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.935 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.935 g/cc, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cc, which are generally prepared with Ziegler-Natta catalysts, single-site catalysts including, but not limited to, bis-metallocene catalysts and constrained geometry catalysts, and post-metallocene, molecular catalysts. The term “propylene-based polymer,” as used herein, refers to a polymer that comprises, in polymerized form, refers to polymers comprising greater than 50% by weight of units which have been derived from propylene monomer. This includes propylene homopolymer, random copolymer polypropylene, impact copolymer polypropylene, propylene/α-olefin copolymer, and propylene/α-olefin copolymer. These polypropylene materials are generally known in the art.

As used herein, the term “styrenic block copolymer” refers to a block copolymer that is produced from the polymerization of styrene monomer and at least one other comonomer. Additionally, as used herein, Molecular Weight Distribution (MWD) of a polymer is defined as the quotient Mw/Mn, where Mw is a weight average molecular weight of the polymer and Mn is a number average molecular weight of the polymer. While melt index (I₂), as used herein, is a measure of melt flow rate of a polymer as measured by ASTM D1238 at a temperature of 190° C. and a 2.16 kg load.

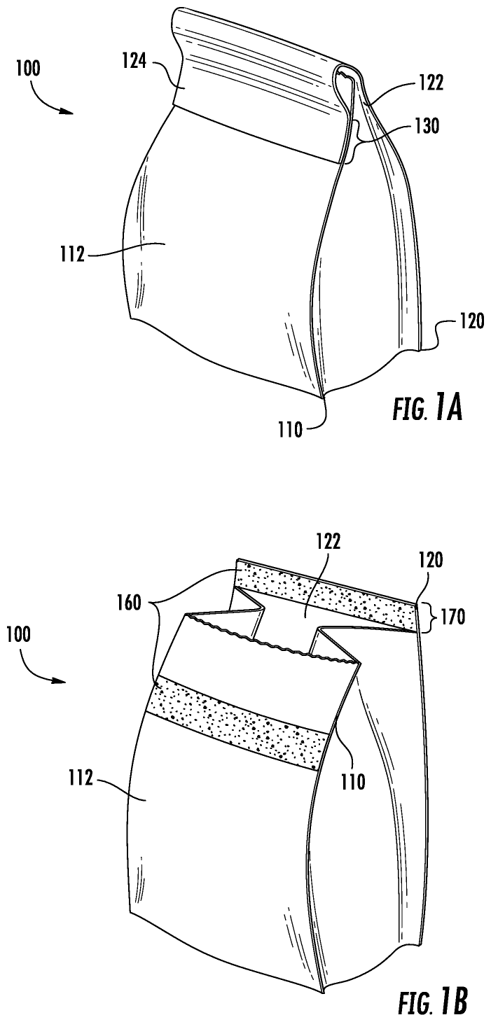

Referring to FIGS. 1A and 1B, FIG. 1A represents a reclosable package 100 in the closed position. In one or more embodiments, application of a force greater than the first adhesion strength to the rear wall 120 in a direction away from the front wall 110 is operable to separate the portion of the surface of the rear wall 120 from the exterior surface 112 of the front wall 110. After this separation, the reclosable package 100 may be in the open position as shown in FIG. 1B.

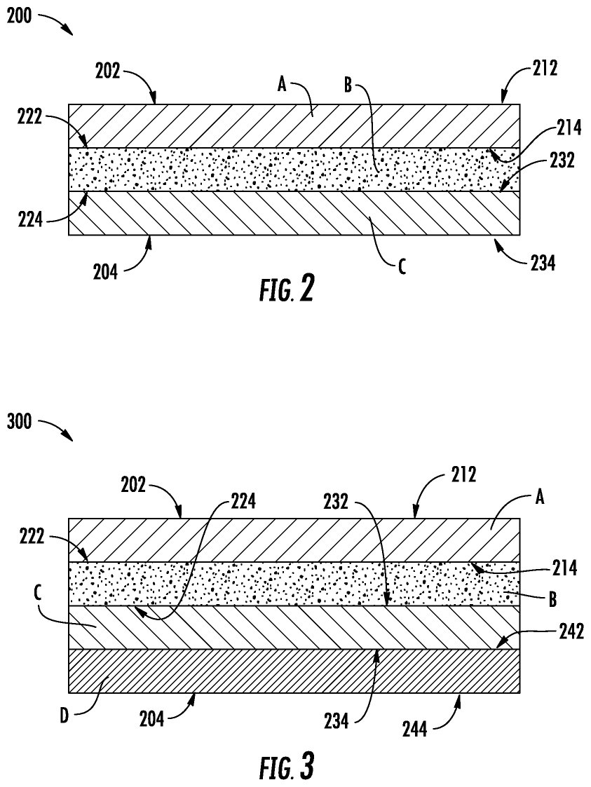

Still referring to FIGS. 1A and 1B, in some embodiments, a reclosable package 100, comprises a front wall 110, a rear wall 120, and an upper closure 130 at which at least a portion of a surface of the rear wall 120 is sealed to an exterior surface 112 of the front wall 110 at a first adhesion strength. The front wall 110 has a height, a width, an interior surface, an exterior surface 112, and a thickness defined between the interior surface and the exterior surface 112. The rear wall 120 has a height, a width, an interior surface 122, an exterior surface 124, and a thickness defined between the interior surface 122 and the exterior surface 124. The rear wall 120 may optionally comprise a tab 170 that extends from the top edge of the rear wall 120. In one or more embodiments, the tab 170 may comprise an adhesive. In still other embodiments, the tab 170 may be in adhering contact with the exterior surface 112 of the front wall 110. In one embodiment, shown in FIG. 2B, the tab 170 is rectangular in shape. In other embodiments, triangular, trapezoidal, curved, ovoid, circular, semi-circular, flanged, or similarly shaped tabs 170 are contemplated. In one or more embodiments, the tab 170 has substantially the same width as the rear wall 120. In other embodiments, the tab 170 is narrower or wider than the rear wall 120. In some embodiments, the tab 170 includes multiple extending edges that may or may not be involved in the seal between the front wall 110 and the rear wall 120 at the upper closure 130.

The front wall 110 and the rear wall 120 may be generally parallel to each other or they may be disposed at an angle to each other. The front wall 110 and rear wall 120 may have similar dimensions or disparate dimensions. In one or more embodiments, the front wall 110 and rear wall 120 may be sealed longitudinally along either or both sides. In other embodiments, the front wall 110 and rear wall 120 may be joined by one or more side walls. Similarly, in other embodiments, the front wall 110 and the rear wall 120 may be sealed across a width at a bottom opposite the upper closure 130. In other embodiments, the front wall 110 and rear wall 120 may be joined by a bottom wall coupled to the ends of the front wall 110 and rear wall 120 opposite the upper closure 130.

In one or more embodiments, the front wall 110 and rear wall 120 of the reclosable package 100 may comprise a rigid material such as, by way of non-limiting example, cardboard. In other embodiments, the front wall 110, the rear wall 120, or both of the reclosable package 100 may comprise a flexible material such as a flexible film. In other embodiments, the front wall 110 and rear wall 120 may comprise a flexible material that comprises polyethylene such as HDPE, MDPE, LDPE, LLDPE, VLDPE, or combinations thereof. In one or more embodiments, the front wall 110, the rear wall 120, or both of the reclosable package 100 may comprise polyamides, polyethylene terephthalate (PET), other polyesters, polypropylene, other polyolefins, polyvinyl chloride, or other thermoplastic polymers, or even combinations thereof. In one or more embodiments, the front wall 110, the rear wall 120, or both may comprise a reclose film, as described herein.

In one or more embodiments, at the upper closure 130, at least a portion of the surface of the rear wall 120 may be sealed to an exterior surface 112 of the front wall 110 at a first adhesion strength. In one or more embodiments, the upper closure 130 may include an adhesive composition disposed between the surface of the rear wall 120 and an exterior surface 112 of the front wall 110. In one or more embodiments, adhesive may include any of the compositions subsequently described in this disclosure. In one or more embodiments, the application of a force greater than the first adhesion strength to the rear wall 120 in a direction away from the front wall 110 is operable to separate the portion of the surface of the rear wall 120 from the exterior surface 112 of the front wall 110. In one or more embodiments, the force may be applied generally perpendicularly to the exterior surface 112 of the front wall 110.

In one or more embodiments the first adhesion strength may be less than or equal to 40 newtons/inch (N/inch). In one or more embodiments, the first adhesion strength may be representative of the overall bond strength of the portion of the surface of the rear wall 120 to the exterior surface 112 of the front all 110. In one or more embodiments, the first adhesion strength may be less than or equal to 37 N/inch, less than or equal to 35 N/inch, or even less than or equal to 30 N/inch after being heat sealed at a heat sealing temperature of at least 150° C. The first adhesion strength may be determined according to the test method for peel strength described herein. In some embodiments, the reclosable package 100 may have a first adhesion strength of from 25 N/inch to 40 N/inch, from 25 N/inch to 37 N/inch, from 25 N/inch to 35 N/inch, from 27 N/inch to 40 N/inch, from 27 N/inch to 37 N/inch, from 27 N/inch to 35 N/inch, from 30 N/inch to 40 N/inch, from 30 N/inch to 37 N/inch, or from 30 N/inch to 35 N/inch after being heat sealed at a heat sealing temperature of 130° C. The force greater than the first adhesion strength being applied to the rear wall 120 in a direction away from the front wall 110 may be operable to separate the portion of the surface 122 of the rear wall 120 from the exterior surface 112 of the front wall 110. This force greater than the first adhesion strength may also be referred to herein as the initial opening force.

Referring to FIG. 1B, in one or more embodiments, when a force greater than the first adhesion strength is applied, the rear wall 120 may separate from the front wall 110 and expose a reclose region 160 on the exterior surface 112 of the front wall 110. In one or more embodiments, the separating of the rear wall 120 from the front wall 110 may expose reclose regions 160 on the exterior surface 112 of the front wall 110 and a surface of the rear wall 120. In other embodiments, the rear wall 120 may comprise a tab 170. In embodiments where the upper closure 130 comprises a portion of a surface of the tab 170, the separation of the portion a surface 122 of the rear wall 120 from the exterior surface 112 of the front wall 110 may expose a reclose region 160 on the tab 170.

In one or more embodiments, the return of a portion of the surface 122 of the rear wall 120 into contact with the reclose region 160 and application of a force on the rear wall 120 in the direction of the reclose region 160 may be operable to reseal the portion of the surface 122 of the rear wall 120 to the exterior surface 112 of the front wall 110 at a second adhesion strength. As used herein, the term “reclose” refers to the application of this force to reseal the package 100.

In one or more embodiments, after the resealing of the separated portion of the surface 122 of the rear wall 120 to the exterior surface 112 of the front wall 110 at a second adhesion strength, the application of a force greater than the second adhesion strength to the rear wall 120 in a direction away from the front wall 110 may be operable to separate at least a portion of the surface of the rear wall 120 from the exterior surface 112 of the front wall 110, thereby reopening the package 100. As used herein, the term “reopen” refers to the application of this force greater than the second adhesion strength.

In one or more embodiments, the return of a portion of the surface 122 of the rear wall 120 and the application of a force to reseal may transition the reclosable package 100 from an open state as shown in FIG. 1B to the closed state, as illustrated in FIG. 1A. Transitioning the reclosable package 100 from the open state to the closed state by return of the portion of the surface of the rear wall 120 into contact with the reclose region 160 and application of a force on the rear wall 120 in the direction of the reclose region 160 and then transitioning the reclosable package 100 from the closed state to the open state by the application of a force to the rear wall 120 in a direction away from the front wall 110 is known as one reclose and reopen cycle.

In some embodiments, the adhesive composition may exhibit a reclose peel adhesion force of greater than or equal to 2.0 N/inch after being heat sealed at a heat seal temperature of 150° C., initially opened, and after experiencing at least 4 reclose and reopen cycles. In some embodiments, the adhesive composition may exhibit a reclose peel adhesion force of greater than or equal to 2.5 N/inch, greater than or equal to 3.0 N/inch, or even greater than 3.5 N/inch after being heat sealed at a heat seal temperature of 150° C., initially opened, and after experiencing at least 4 reclose and reopen cycles. In some embodiments, the adhesive composition may exhibit a reclose peel adhesion force of from 2.0 N/inch to 10.0 N/inch, from 2.0 N/inch to 7.0 N/inch, from 2.0 N/inch to 5.0 N/inch, from 2.5 N/inch to 10.0 N/inch, from 2.5 N/inch to 7.0 N/inch, or from 2.5 N/inch to 5.0 N/inch after being heat sealed at a heat seal temperature of 150° C., initially opened, and after experiencing at least 4 reclose and reopen cycles.

In one or more embodiments, the front wall 110, the rear wall 120, the upper closure 130, or combinations thereof may include a reclose film. In other embodiments, the upper closure 130 may include a strip of reclose film disposed between the surface of the rear wall 120 and the exterior surface 112 of the front wall 110. As used in the present disclosure, a reclose film may be a multilayer film comprising at least three layers: an A layer, a B layer, and a C layer. Layer A may be a sealant layer, Layer B may be a reclose layer and may include the compositions described herein, and Layer C may include a support material, such as a polyolefin or other support material or a sealant layer, for example. Referring to FIG. 2, Layer B is positioned proximal to Layer A with a top facial surface 222 of Layer B in adhering contact with a bottom facial surface 214 of Layer A. A top facial surface 232 of Layer C is in adhering contact with the bottom facial surface 224 of Layer B.

In one or more embodiments, the adhesive of Layer B comprises an ethylene/α-olefin random copolymer, a styrenic block copolymer, a tackifier, and an oil. The adhesive composition of Layer B may also provide the reclose and reopen functionality to the reclose film or reclosable package. Additionally, the adhesive composition is safe and suitable for use in food packaging applications. For example, some conventional reclose films may include compositions having a high concentration of greater than 50 weight percent of styrenic block copolymers. Materials having greater than 50 wt. % styrene block copolymers are known to influence the odor and taste of food products packaged in these materials. The adhesive compositions of the present disclosure include reduced concentrations of styrenic block copolymers compared to conventional reclose films. Therefore, the adhesive compositions of the present disclosure and the multilayer films and packages made therewith may provide reclosability to food packaging films without changing the odor or taste of the food packaged in the films.

The ethylene/α-olefin random copolymer of the compositions may be a copolymer of ethylene comonomer and at least one α-olefin comonomer (i.e., alpha olefin comonomer). Suitable α-olefin comonomers may include those containing 3 to 20 carbon atoms (C₃-C₂₀ α-olefins). In some embodiments, the α-olefin comonomer may be a C₃-C₂₀ α-olefin, a C₃-C₁₂ α-olefin, a C₃-C₁₀ α-olefin, a C₃-C₈ α-olefin, a C₄-C₂₀ α-olefin, a C₄-C₁₂ α-olefin, a C₄-C₁₀ α-olefin, or a C₄-C₈ α-olefin. In one or more embodiments, the ethylene/α-olefin random copolymer may be a copolymer of ethylene comonomer and one or more co-monomers selected from propylene, 1-butene, 3-methyl-1-butene, 1-pentene, 3-methyl-1-pentene, 4-methyl-1-pentene, 1-hexene, 1-septene, 1-octene, 1-nonene, 1-decene, 1-dodecene, 1-tetradecene, 1-hexadecene, 1-octadecene, and 1-eicosene. In one or more embodiments, the ethylene/α-olefin random copolymer may be a copolymer of ethylene comonomer and 1-hexene comonomer. In one or more embodiments, the ethylene/α-olefin random copolymer may be an ethylene/octene copolymer that may be made from ethylene comonomer and octene comonomer.

A weight percent of ethylene monomer units in the ethylene/α-olefin random copolymer may be greater than 50 wt. % in one or more embodiments, or greater than or equal to 55 wt. % in other embodiments, or greater than or equal to 60 wt. % in yet other embodiments, or greater than or equal to 65 wt. % in yet other embodiments. In some embodiments, the ethylene/α-olefin random copolymer may include from greater than 50 wt. % to 70 wt. %, from greater than 50 wt. % to 65 wt. %, from greater than 50 wt. % to 60 wt. %, from 55 wt. % to 70 wt. %, from 55 wt. % to 65 wt. %, from 55 wt. % to 60 wt. %, from 60 wt. % to 70 wt. %, from 60 wt. % to 65 wt. %, or from 65 wt. % to 70 wt. % ethylene monomer units. Conversely, a weight percent of the α-olefin comonomer in the first polyethylene resin may be less than 50 wt. % in one or more embodiments, or less than or equal to 45 wt. % in other embodiments, or less than or equal to 40 wt. % in yet other embodiments, or less than or equal to 35 wt. % in yet other embodiments.

The ethylene/α-olefin random copolymer may have a density of less than or equal to 0.890 grams per centimeter cubed (g/cm³). In some embodiments, the ethylene/α-olefin random copolymer may have a density that is less than or equal to 0.880 g/cm³, or even less than 0.87 g/cm³. The density of the ethylene/α-olefin random copolymer is measured in accordance with ASTM D792. In one or more embodiments, the ethylene/α-olefin random copolymer may have a density of from 0.850 g/cm³ to 0.890 g/cm³. In one or more embodiments, the ethylene/α-olefin random copolymer may have a density of from 0.850 g/cm³ to 0.880 g/cm³, from 0.850 g/cm³ to 0.870 g/cm³, from 0.860 g/cm³ to 0.890 g/cm³, or 0.860 g/cm³ to 0.880 g/cm³.

The ethylene/α-olefin random copolymer may have a melting point of less than or equal to 100 degrees Celsius (° C.). For example, in some embodiments, the ethylene/α-olefin random copolymer may have a melting point of less than or equal to 95° C., less than or equal to 90° C., less than or equal to 80° C., or even less than or equal to 75° C. In some embodiments, the ethylene/α-olefin random copolymer may have a melting point of greater than room temperature, such as greater than or equal to 30° C. or even greater than or equal to 40° C. In some embodiments, the ethylene/α-olefin random copolymer may have a melting point of from 30° C. to 100° C., from 30° C. to 95° C., from 30° C. to 90° C., from 30° C. to 80° C., from 30° C. to 75° C., from 40° C. to 100° C., from 40° C. to 95° C., from 40° C. to 90° C., from 40° C. to 80° C., or from 40° C. to 75° C.

The ethylene/α-olefin random copolymer may have a melt index (I₂), which is measured according to ASTM D1238 at 190° C. and 2.16 kg load, of from 0.2 grams per 10 minutes (g/10 min) to 8.0 g/10 min, from 0.2 g/10 min to 5.0 g/10 min, from 0.2 g/10 min to 3.0 g/10 min, from 0.2 g/10 min to 1.5 g/10 min, from 0.2 g/10 min to 1.0 g/10 min, from 0.5 g/10 min to 8.0 g/10 min, from 0.5 g/10 min to 5.0 g/10 min, from 0.5 g/10 min to 3.0 g/10 min, from 0.5 g/10 min to 1.5 g/10 min, from 0.5 g/10 min to 1.0 g/10 min, from 1.0 g/10 min to 8.0 g/10 min, from 1.0 g/10 min to 5.0 g/10 min, from 1.0 g/10 min to 3.0 g/10 min, or from 3.0 g/10 min to 8.0 g/10 min. In one or more embodiments, the ethylene/α-olefin random copolymer may have a melt index (I₂) of from 0.2 g/10 min to 8.0 g/10 min. In one or more other embodiments, the ethylene/α-olefin random copolymer may have a melt index (I₂) of from 0.5 g/10 min to 1.5 g/10 min.

The ethylene/α-olefin random copolymer may have a molecular weight distribution (MWD or Mw/Mn) of from 1.0 to 3.5, from 1.0 to 3.0, from 1.0 to 2.5, from 1.0 to 2.2, from 1.0 to 2.0, from 1.3 to 3.5, from 1.3 to 3.0, from 1.3 to 2.5, from 1.3 to 2.2, from 1.3 to 2.0, from 1.7 to 3.5, from 1.7 to 3.0, from 1.7 to 2.5, from 1.7 to 2.2, or from 1.7 to 2.0. In one or more embodiments, the ethylene/α-olefin random copolymer may have a MWD of from 1.0 to 3.5. Mw is the weight average molecular weight and Mn is the number average molecular weight, both of which may be measured by gel permeation chromatography (GPC).

The dynamic melt viscosity of the ethylene/α-olefin random copolymer may be measured using Dynamic Mechanical Spectroscopy (DMS), which is described subsequently in this disclosure. In some embodiments, the ethylene/α-olefin random copolymer may have a ratio of the dynamic melt viscosity at 0.1 radians per second to the dynamic melt viscosity at 100 radians per second of less than or equal to 20 at a temperature of 110° C. as determined by DMS. In some embodiments, the ethylene/α-olefin random copolymer may have a ratio of the dynamic melt viscosity at 0.1 radians per second to the dynamic melt viscosity at 100 radians per second of less than or equal to 15 at a temperature of 130° C. as determined by DMS. In some embodiments, the ethylene/α-olefin random copolymer may have a ratio of the dynamic melt viscosity at 0.1 radians per second to the dynamic melt viscosity at 100 radians per second of less than or equal to 10 at a temperature of 150° C. as determined by DMS.

The ethylene/α-olefin random copolymer may be made by gas-phase, solution-phase, or slurry polymerization processes, or any combination thereof, using any type of reactor or reactor configuration known in the art, e.g., fluidized bed gas phase reactors, loop reactors, continuous stirred tank reactors, batch reactors in parallel, series, or any combinations thereof. In some embodiments, gas or slurry phase reactors are used. In some embodiments, the ethylene/α-olefin random copolymer is made in a gas-phase or slurry process such as that described in U.S. Pat. No. 8,497,330, which is herein incorporated by reference in its entirety. The ethylene/α-olefin random copolymer may also be made by a high pressure, free-radical polymerization process. Methods for preparing the ethylene/α-olefin random copolymer by high pressure, free radical polymerization can be found in U.S. 2004/0054097, which is herein incorporated by reference in its entirety, and can be carried out in an autoclave or tubular reactor as well as any combination thereof. Details and examples of a solution polymerization of ethylene monomer and one or more α-olefin comonomers in the presence of a Ziegler-Natta catalyst are disclosed in U.S. Pat. Nos. 4,076,698 and 5,844,045, which are incorporated by reference herein in their entirety. The catalysts used to make the ethylene/α-olefin random copolymer described herein may include Ziegler-Natta, metallocene, constrained geometry, single site catalysts, or chromium-based catalysts.

Exemplary suitable ethylene/α-olefin random copolymers may include, but may not be limited to, AFFINITY™ EG 8100 ethylene/α-olefin random copolymer and ENGAGE™ 8842 ethylene/α-olefin copolymer supplied by The Dow Chemical Company, Midland, Mich.

The pressure sensitive adhesive composition may include from 30 wt. % to 65 wt. % ethylene/α-olefin random copolymer. For example, in some embodiments, the adhesive composition may include from 30 wt. % to 55 wt. %, from 33 wt. % to 65 wt. %, or from 33 wt. % to 55 wt. % ethylene/α-olefin random copolymer.

As previously discussed, the adhesive composition includes a styrenic block copolymer. The styrenic block copolymer contains from greater than 1 wt. % to less than 50 wt. % styrene. In some embodiments, the styrenic block copolymer may include from 10 wt. % styrene to less than 50 wt. % styrene. The styrene monomer may be styrene or a styrene derivative, such as alpha-methyl styrene, 4-methylstyrene, 3,5-diethylstyrene, 2-ethyl-4-benzylstyrene, 4-phenylstyrene, or mixtures thereof. In one embodiment, the styrene monomer is styrene. Various olefin or diolefin (diene) comonomers are contemplated as suitable for polymerizing with the styrene. The olefin comonomer may comprise C₃-C₂₀ α-olefins. The diolefin comonomers may include various C₄-C₂₀ olefins such as 1,3-butadiene, 1,3-cyclohexadiene, isoprene, 1,3-pentadiene, 1,3-hexadiene, 2,3-dimethyl-1,3-butadiene, 2-ethyl-1,3-butadiene, 2-methyl-1,3 pentadiene, 3-methyl-1,3-pentadiene, 4-methyl-1,3-pentadiene, and 2,4-hexadiene, or combinations thereof.

Examples of suitable styrenic block copolymers may include, but are not limited to, styrene-isoprene-styrene block copolymers (SIS), styrene-butadiene-styrene block copolymers (SBS), styrene-ethylene/butylene-styrene block copolymers (SEBS), styrene-isobutylene-styrene block copolymers (SIBS), styrene-ethylene-propylene-styrene block copolymers (SEPS), and mixtures thereof. Examples of styrenic block copolymers may include, but are not limited to, materials commercially available under the tradename “KRATON” such as KRATON D1161, KRATON D1118, KRATON G1657, and the like, available from Kraton Corp., Houston, Tex. or materials commercially available under the trade name “Vector” such as 4113A, 4114A, 4213A, and the like, available from Dexco Polymers, Houston, Tex.

The styrenic block copolymer includes less than 50 wt. % styrene. For example, in some embodiments, the stryrenic block polymer may include less than or equal to 45 wt. %, less than or equal to 40 wt. %, less than or equal to 35 wt. %, less than or equal to 30 wt. %, or even less than or equal to 25 wt. % styrene. In some embodiments, the styrenic block copolymer may have from greater than or equal to 1 wt. % to less than 50 wt. % styrene. In other embodiments, the styrenic block copolymer may have from 5 wt. % to less than 50 wt. %, from 10 wt. % to less than 50 wt. %, from 15 wt. % to less than 50 wt. %, from 20 wt. % to less than 50 wt. %, from 1 wt. % to 45 wt. %, from 1 wt. % to 40 wt. %, from 1 wt. % to 35 wt. %, from 1 wt. % to 30 wt. %, from 1 wt. % to 25 wt. %, from 5 wt. % to less than 50 wt. %, from 5 wt. % to 45 wt. %, from 5 wt. % to 40 wt. %, from 5 wt. % to 35 wt. %, from 5 wt. % to 30 wt. %, from 5 wt. % to 25 wt. %, from 10 wt. % less than 50 wt. %, from 10 wt. % to 45 wt. %, from 10 wt. % to 40 wt. %, from 10 wt. % to 35 wt. %, from 10 wt. % to 30 wt. %, from 10 wt. % to 25 wt. %, from 15 wt. % to less than 50 wt. %, from 15 wt. % to 45 wt. %, from 15 wt. % to 40 wt. %, from 15 wt. % to 35 wt. %, from 15 wt. % to 30 wt. %, or from 15 wt. % to 25 wt. % styrene. In some embodiments, the styrenic block copolymer including less than 50 wt. % styrene may include an amount of non-styrenic copolymer that is sufficient to interact with the tackifier. In some embodiments, the styrenic block copolymer may be SIS and the styrenic block copolymer may include from 15 wt. % to 25 wt. % styrene. In other embodiments, the styrenic block copolymer may be SIS and may include from 20 wt. % to 25 wt. % styrene.

The compositions disclosed herein may include from 10 wt. % to 35 wt. % styrenic block copolymer based on the total weight of the composition. For example, in some embodiments, the compositions may include from 10 wt. % to 30 wt. % styrenic block copolymer based on the total weight of the composition.

The tackifier may be a resin added to the compositions disclosed herein to reduce the modulus and increase the surface adhesion of the compositions compared to the compositions without the tackifier. In some embodiments, the tackifier may be a hydrocarbon tackifier. The tackifier may include, but is not limited to, non-hydrogenated aliphatic C₅ (five carbon atoms) resins, hydrogenated aliphatic C₅ resins, aromatic modified C₅ resins, terpene resin, hydrogenated C₉ resins, or combinations thereof. In some embodiments, the tackifier may be selected from the group consisting of a non-hydrogenated aliphatic C₅ resin and a hydrogenated aliphatic C₅ resin. In some embodiments, the composition may include a plurality of tackifiers.

In some embodiments, the tackifier may have a density from 0.92 g/cm³ to 1.06 g/cm³. The tackifier may exhibit a Ring and Ball softening temperature of from 80° C. to 140° C., from 85° C. to 130° C., from 90° C. to 120° C., from 90° C. to 110° C., or from 91° to 100° C. The Ring and Ball softening temperature may be measured in accordance with ASTM E 28. In some embodiments, the tackifier may exhibit a melt viscosity of less than 1000 Pascal second (Pa-s) at 175° C. For example, in other embodiments, the tackifier may exhibit a melt viscosity of less than or equal to 500 Pa-s, less than or equal to 200 Pa-s, less than or equal to 100 Pa-s, or even less than or equal to 50 Pa-s at 175° C. Further, in some embodiments, the tackifier may exhibit a melt viscosity greater than or equal to 1 Pa-s or greater than or equal to 5 Pa-s at 175° C. In a some embodiments, the tackifier may exhibit a melt viscosity from 1 Pa-s to less than 100 Pa-s, or to less than 50 Pa-s at 175° C. The melt viscosity of the tackifier may be determined using dynamic mechanical spectroscopy (DMS).

The C₅ resin for a “C₅ tackifier” may be obtained from C₅ feedstocks such as pentenes and piperylene. The terpene resin for a tackifier may be based on pinene and d-limonene feedstocks. Examples of suitable tackifiers may include, but are not limited to, tackifiers sold under the tradename PICCOTAC, REGALITE, REGALREZ, and PICCOLYTE, such as PICCOTAC 1100, PICCOTAC 1095, REGALITE R1090, and REGALREZ 11126, available from The Eastman Chemical Company, and PICCOLYTE F-105 from PINOVA.

The compositions disclosed herein may include from 20 wt. % to 40 wt. % tackifier. In some embodiments, the compositions may have from 20 wt. % to 35 wt. %, from 20 wt. % to 30 wt. %, from 25 wt. % to 40 wt. %, from 25 wt. % to 35 wt. %, or from 25 wt. % to 30 wt. % tackifier based on the total weight of the composition.

As previously discussed, the compositions disclosed herein may also include an oil. In some embodiments, the oil may include greater than 95 mole % aliphatic carbon compounds. In some embodiments, the oil may exhibit a glass transition temperature for the amorphous portion of the oil that is less than −70° C. In some embodiments, the oil can be a mineral oil. Examples of suitable oils may include, but are not limited to, mineral oil sold under the tradenames HYDROBRITE 550 (Sonneborn), PARALUX 6001 (Chevron), KAYDOL (Sonneborn), BRITOL 50T (Sonneborn), CLARION 200 (Citgo), CLARION 500 (Citgo), or combinations thereof. In some embodiments, the oil may comprise a combination or two or more oils described herein. The compositions disclosed herein may include from greater than 0 wt. % to 8 wt. % oil. For example, in some embodiments, the compositions may include from greater than 0 wt. % to 7 wt. %, from 3 wt. % to 8 wt. %, from 3 wt. % to 7 wt. %, from 5 wt. % to 8 wt. %, or from 5 wt. % to 7 wt. % oil based on the total weight of the composition.

The present compositions may optionally include one or more additives. Examples of suitable additives may include, but are not limited to, antioxidants, ultraviolet absorbers, antistatic agents, pigments, viscosity modifiers, anti-block agents, release agents, fillers, coefficient of friction (COF) modifiers, induction heating particles, odor modifiers/absorbents, and any combination thereof. In an embodiment, the compositions further comprise one or more additional polymers. Additional polymers include, but are not limited to, ethylene-based polymers and propylene-based polymers.

In some embodiments, the compositions disclosed herein may include from 30 wt. % to 65 wt. % ethylene/α-olefin random copolymer, from 10 wt. % to 35 wt. % styrenic block copolymer, from 20 wt. % to 40 wt. % tackifier, and from greater than 0 wt. % to 8 wt. % oil. In other embodiments, the compositions may include from 33 wt. % to 55 wt. % ethylene/α-olefin random copolymer, from 10 wt. % to 30 wt. % styrenic block copolymer, from 25 wt. % to 30 wt. % tackifier, and from 5 wt. % to 7 wt. % oil.

In some embodiments, the compositions may have an overall density of less than or equal to 0.930 g/cm³, or less than or equal to 0.920 g/cm³. In some embodiments, the compositions may have an overall density of from 0.880 g/cm³ to 0.930 g/cm³, from 0.880 g/cm³ to 0.920 g/cm³, from 0.890 g/cm³ to 0.930 g/cm³, or from 0.89 g/cm³ to 0.92 g/cm³.

In some embodiments, the compositions may exhibit an overall melt index (I₂) of from 2 grams per 10 minutes (g/10 min) to 15 g/10 min. For example, in some embodiments, the compositions may exhibit an overall melt index (I₂) of from 2 g/10 min to 14 g/10 min, from 2 g/10 min to 12 g/10 min, from 2 g/10 min to 10 g/10 min, from 3 g/10 min to 15 g/10 min, from 3 g/10 min to 14 g/10 min, from 3 g/10 min to 12 g/10 min, from 3 g/10 min to 10 g/10 min, from 5 g/10 min to 15 g/10 min, from 5 g/10 min to 14 g/10 min, from 5 g/10 min to 12 g/10 min, from 5 g/10 min to 10 g/10 min, from 7 g/10 min to 15 g/10 min, from 7 g/10 min to 14 g/10 min, from 7 g/10 min to 12 g/10 min, or from 7 g/10 min to 10 g/10 min. The overall melt index (I₂) is determined according to ASTM D1238 at 190° C. and 2.16 kg load.

The dynamic melt viscosity may be determined using Dynamic Mechanical Spectroscopy (DMS) at a various testing temperatures and testing frequency. The compositions may exhibit a dynamic melt viscosity of from 1,000 Pa-s to 1,400 Pa-s measured using DMS at a temperature of 190° C. and a frequency of 1 Hz. The compositions may exhibit a dynamic melt viscosity of from 3,200 Pa-s to 4,000 Pa-s measured using DMS at a temperature of 150° C. and a frequency of 1 Hz. The compositions may exhibit a dynamic melt viscosity of from 7,400 Pa-s to 7,800 Pa-s measured using DMS at a temperature of 130° C. and a frequency of 1 Hz. The compositions may exhibit a dynamic melt viscosity of from 12,400 Pa-s to 17,200 Pa-s measured using DMS at a temperature of 110° C. and a frequency of 1 Hz.

In some embodiments, the compositions disclosed herein may exhibit a melt temperature of less than or equal to 100° C., less than or equal to 90° C., or even less than or equal to 80° C. In some embodiments, the compositions may exhibit a melt temperature of from 60° C. to 100° C., from 60° C. to 90° C., from 60° C. to 80° C., from 70° C. to 100° C., or from 70° C. to 90° C. In some embodiments, the compositions may exhibit no melting peaks above 100° C.

The compositions may exhibit an initial internal cohesion force of less than or equal to 40 newtons/inch (N/in), less than or equal to 37 N/in, less than 35 N/in, or even less than 30 N/in after being heat sealed at a heat sealing temperature of 150° C. The initial internal cohesion force of the compositions may be determined according to the test method for peel strength described herein. In some embodiments, the compositions may exhibit an initial internal cohesion force of from 25 N/in to 40 N/in, from 25 N/in to 37 N/in, from 25 N/in to 35 N/in, from 27 N/in to 40 N/in, from 27 N/in to 37 N/in, from 27 N/in to 35 N/in, from 30 N/in to 40 N/in, from 30 N/in to 37 N/in, or from 30 N/in to 35 N/in after being heat sealed at a heat sealing temperature of 130° C.

In some embodiments, the compositions may exhibit a reclose peel adhesion force of greater than or equal to 1.0 N/in after being heat sealed at a heat seal temperature of 150° C., initially opened, and after experiencing at least 4 reclose-reopen cycles. In some embodiments, the compositions may exhibit a reclose peel adhesion force of greater than or equal to 1.5 N/in, greater than or equal to 2.0 N/in, or even greater than 2.5 N/in after being heat sealed at a heat seal temperature of 150° C., initially opened, and after experiencing at least 4 reclose-reopen cycles. In some embodiments, the compositions may exhibit a reclose peel adhesion force of from 2.0 N/in to 10.0 N/in, from 2.0 N/in to 7.0 N/in, from 2.0 N/in to 5.0 N/in, from 2.5 N/in to 10.0 N/in, from 2.5 N/in to 7.0 N/in, or from 2.5 N/in to 5.0 N/in after being heat sealed at a heat seal temperature of 150° C., initially opened, and after experiencing at least 4 reclose-reopen cycles.

The compositions disclosed herein may be compounded using a single stage twin-screw extrusion process or any other conventional blending or compounding process.

The compositions disclosed herein may be incorporated into a multilayer film, which may provide reclose functionality to packaging made from the multilayer film. The multilayer film may include at least three layers: a sealing layer forming a facial surface of the multilayer film, a reclose layer in adhering contact with the sealing layer, and at least one supplemental layer in adhering contact with the reclose layer. The sealing layer may seal the multilayer film to a substrate, such as a surface of a container, another flexible film, or to itself, for example. The reclose layer, once activated by exerting an initial opening force on the multilayer film, may provide reclose/reopen functionality to the multilayer film. At least one supplemental layer may provide structural support to the multilayer film or may provide an additional sealing layer.

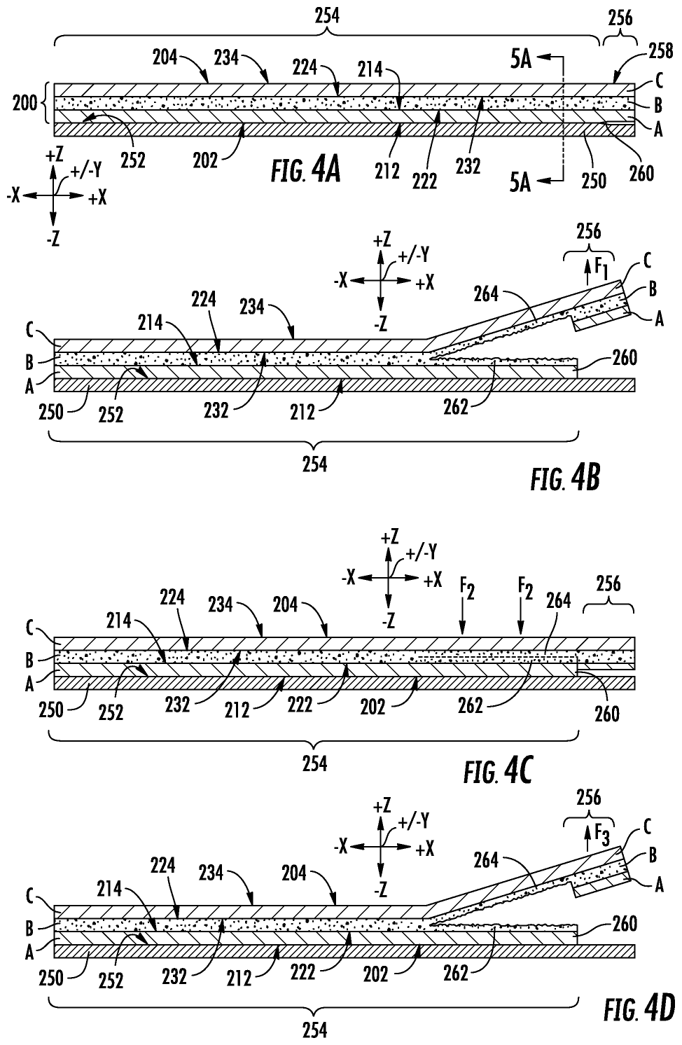

Referring to FIG. 3, the reclose film 200 is illustrated that includes at least three layers: Layer A, Layer B, and Layer C. The reclose film 200 will be described relative to an embodiment having three layers; however, the multilayer film may have more than three layers, such as four, five, six, seven, eight, or even more than 8 layers. For example, referring to FIG. 4, the multilayer film may have 4 layers: Layer A, Layer B, Layer C, and Layer D. Reclose films with more than 4 layers are also contemplated.

Referring again to FIG. 3, the reclose film 200 may have a film top facial surface 202 and a film bottom facial surface 204. Similarly, each of the layers A, B, and C may have opposing facial surfaces, such as a top facial surface and a bottom facial surface. As used in this disclosure, the term “top” refers to the facial surface of the multilayer oriented toward the Layer A side of the reclose film 200, and the term “bottom” refers to the opposite side of the reclose film 200 oriented away from the Layer A side of the reclose film 200.

Layer A may have a top facial surface 212 and a bottom facial surface 214. The top facial surface 212 of Layer A may be the film top facial surface 202 of the reclose film 200. The bottom facial surface 214 of Layer A may be in adhering contact with the top facial surface 222 of Layer B.

Layer A is a sealing layer that includes a sealing composition capable of sealing the film top facial surface 202 of the reclose film 200 to a surface of a substrate or to itself. For example, in some embodiments, the sealing composition may be a heat sealing composition. In some embodiments, the sealing composition may be capable of hermitically sealing the film top facial surface 202 of the reclose film 200 to a surface of a substrate or to itself. In some embodiments, the sealing composition may include a polyolefin. For example, in some embodiments, the sealing composition of Layer A may include at least one of low density polyethylene (LDPE), linear low density polyethylene (LLDPE), ultra-low density polyethylene (ULDPE), ethylene vinyl acetate (EVA), ionomers, polyolefin elastomers, other sealing composition, or combinations of these. Examples of sealing compositions may include, but are not limited to, AFFINITY™ polyolefin elastomer supplied by The Dow Chemical Company, Midland, Mich. In some embodiments, Layer A does not include the composition previously described in this disclosure. The sealing composition of Layer A has an internal cohesive strength greater than the internal cohesive strength of the composition of Layer B.

The sealing composition of Layer A may have an internal cohesion strength that is greater than the internal cohesion strength of the composition of Layer B. During initial opening of the reclose film 200, such as when opening a resealable package made with the reclose film 200, the initial opening force causes the sealing composition of Layer A to fail in a direction generally perpendicular to the reclose film 200. Failure of the sealing composition of Layer A may enable the composition of Layer B to cohesively fail in a direction generally parallel to the reclose film 200 to activate the reclose functionality. Therefore, the internal cohesion strength of Layer A may be low enough so that the magnitude of the opening force needed to initially open the reclose film 200 and activate the reclose and reopen functionality is not excessive.

Referring to FIG. 3, Layer B includes the top facial surface 222 and a bottom facial surface 224. The top facial surface 222 of Layer B may be in adhering contact with the bottom facial surface 214 of Layer A. Additionally, the bottom facial surface 224 of Layer B may be in adhering contact with a top facial surface 232 of Layer C. Thus, Layer B is positioned adjacent to Layer A and in adhering contact with Layer B, and Layer B is disposed between Layer A and Layer C. Layer B comprises the compositions previously described in this disclosure that include the ethylene/α-olefin random copolymer, styrenic block copolymer, tackifier, and oil.

Layer C includes the top facial surface 232 and a bottom facial surface 234. As previously discussed, the top facial surface 232 of Layer C may be in adhering contact with the bottom facial surface 224 of Layer B. In some embodiments, the bottom facial surface 234 of Layer C may comprise the film bottom facial surface 204 of the reclose film 200, such as when the reclose film 200 includes three layers. Alternatively, in other embodiments, the bottom facial surface 234 of Layer C may be in adhering contact with a top facial surface of a subsequent layer. For example, referring to FIG. 4, the bottom facial surface 234 of Layer C may be in adhering contact with a top facial surface 242 of Layer D.

In some embodiments, Layer C may be a structural layer that may provide strength and stiffness to the reclose film 200. In some embodiments, Layer C may include a polymer or copolymer comprising at least an ethylene monomer, such as, but not limited to high density polyethylene (HDPE), medium density polyethylene (MDPE), low density polyethylene (LDPE), linear low density polyethylene (LLDPE), very low density polyethylene (VLDPE), or combinations of these. For example, in some embodiments, Layer C may include LLDPE. In other embodiments, Layer C may include other polymer film materials, such as nylon, polypropylene, polyesters such as polyethylene terephthalate (PET) for example, polyvinyl chloride, other thermoplastic polymers, or combinations of these. In some embodiments, Layer C may include additional structural materials, such as nylon for example. In other embodiments, Layer C may be a sealant layer that includes any of the sealant compositions previously discussed in relation to Layer A.

In some embodiments, the reclose film 200 may be a flexible film, which may enable the reclose film 200 to conform its shape to seal to various substrates and substrate surfaces.

Additional supplemental layers may be added to the bottom facial surface 234 of Layer C to impart any of a number of properties to the multilayer film. For Example, referring to FIG. 4, a reclose film 300 that includes four layers is schematically depicted. As shown, reclose film 300 may include Layer A, Layer B, Layer C, and Layer D. Layer A may again be the sealing layer, and Layer B may be the reclose layer in adhering contact with the sealing layer (Layer A). The reclose film 300 depicted in FIG. 4 includes at least two supplemental layers; Layer C and Layer D. Layer C may have the top facial surface 232 in adhering contact with the bottom facial surface 224 of Layer B. The bottom facial surface 234 of Layer C may be in adhering contact with the top facial surface 242 of Layer D. In some embodiments, the bottom facial surface 244 of Layer D may be the film bottom facial surface 204 of the reclose film 300. Alternatively, in other embodiments, the bottom facial surface 244 of Layer D may be in adhering contact with the top facial surface of another supplemental layer.

Each of the supplemental layers, such as Layers C and D and other supplemental layers, may include different materials or combinations of materials that provide different properties to the reclose film 300, such as structural support, insulating properties, moisture resistance, chemical resistance, tear or puncture resistance, optical properties, sealing capability, gas permeability or impermeability properties, friction resistance, other properties, or combinations of these. For example, in some embodiments, Layer C may include materials that provide structural support to the multilayer film, and Layer D may include a sealing composition, such as the sealing compositions previously described for Layer A, to enable sealing of the film bottom facial surface 204 of the reclose film 300 to a second substrate. Layers C and D, as well as other supplemental layers included to the bottom portion of the reclose film 300 may provide a plurality of other functionalities to the reclose film 300.

Referring to FIGS. 3 and 4, each of the plurality of layers, such as Layer A, Layer B, Layer C, and any additional supplemental layers, may be coextruded to form the reclose films 200, 300. For example, in some embodiments, the reclose films 200, 300 may be produced using a blown film process. Alternatively, in other embodiments, the reclose films 200, 300 may be produced using cast film processes. Other conventional processes for producing multilayer films may also be employed to produce the reclose films 200, 300.

Referring to FIGS. 4A-4D, operation of the reclose film 200 will be described. The reclose film 200 may be initially sealed to a surface 252 of a substrate 250. The substrate 250 may be a rigid substrate, such as a rigid container made from plastic, metal, glass, ceramic, coated or uncoated cardboard (e.g., fiberboard, paperboard or other rigid structure made from wood pulp), other rigid material, or combinations of these. Alternatively, the substrate 250 may be a non-rigid or flexible substrate, such as a polymer film, metal foil, paper, natural or synthetic fabric, other flexible substrate, or combinations of these. For example, in some embodiments, the substrate 250 may include another multilayer polymer film. Is some embodiments, the substrate 250 may be the reclose film 200 itself, such as by folding the reclose film 200 and sealing the reclose film 200 to itself or by providing two separate sheets or webs of the reclose film 200.

Referring to FIG. 4A, the reclose film 200 may be sealed to the surface 252 of the substrate 250 by contacting the top facial surface 212 of Layer A with a surface 252 of the substrate 250 and applying heat, pressure, or a combination of heat and pressure to the reclose film 200 to seal the Layer A, which is the sealing layer of the reclose film 200, to the surface 252 of the substrate 250. In some embodiments, Layer A of the reclose film 200 may be heat sealed to the substrate 250. Heat sealing may be accomplished by conventional heat sealing processes which may be operated at heat sealing temperatures of greater than about 130° C. For example, in some embodiments, Layer A of the reclose film 200 may be heat sealed to the surface 252 of the substrate 250 at a heat sealing temperature of from 100° C. to 180° C. In some embodiments, the heat sealing temperature may be from 100° C. to 160° C., from 100° C. to 150° C., from 120° C. to 180° C., from 120° C. to 160° C., from 120° C. to 150° C., from 130° C. to 180° C., from 130° C. to 160° C., or from 130° C. to 150° C.

In some embodiments, only a portion of Layer A of the reclose film 200 is sealed to the surface 252 of the substrate 250 to form a sealed region 254. The portions of the reclose film 200 in which Layer A is not sealed to the surface 252 of the substrate 250 may define an unsealed region 256 of the reclose film 200. In the unsealed region 256, Layer A of the reclose film 200 is not sealed to the surface 52 of the substrate 250 and may be free to move in a direction normal to the surface 252 of the substrate 250 so that Layer A of the reclose film 200 is spaced apart from the substrate 250 in the unsealed region 256. For example, in some embodiments, in the unsealed region 256, the reclose film 200 may be spaced apart from the substrate 250 to define a volume between the reclose film 200 and the substrate 250. Alternatively or additionally, in some embodiments, the unsealed region 256 may provide a tab 258 that may enable a force to be exerted on the reclose film 200 relative to the substrate 250.

In some embodiments, the sealed regions 254 may exhibit a seal integrity sufficient to prevent passage of particulates between the multilayer film 200 and the substrate 250 in the sealed region 254. In other embodiments, seal integrity of the sealed regions 254 may be sufficient to prevent passage of liquids between the multilayer film 200 and the substrate 250 in the sealed region 254. In still other embodiments, seal integrity of the sealed regions 254 may be sufficient to prevent passage of moisture between the multilayer film 200 and the substrate 250 in the sealed region 254. In still other embodiments, seal integrity of the sealed regions 254 may be sufficient to prevent passage of are between the multilayer film 200 and the substrate 250 in the sealed region 254.

Upon sealing the film top facial surface 202 of the reclose film 200 to the surface 252 of the substrate 250 to form the sealed region 254, a bond strength between the bottom facial surface 214 of Layer A and the top facial surface 222 of Layer B may be greater than a cohesive strength of the adhesive composition of Layer B. Additionally, after sealing, a bond strength between the bottom facial surface 224 of Layer B and the top facial surface 232 of Layer C may be also be greater than an internal cohesion strength of the adhesive composition of Layer B. After sealing, the bond strength of the top facial surface 212 of Layer A to the surface 252 of the substrate 250 may be greater than an internal cohesion strength of the composition of Layer B. Therefore, the sealing composition of Layer A does not provide reclose functionality to the reclose film 200. Once sealed to the substrate 250, the reclose film 200 does not exhibit reclose functionality until after an initial opening force is applied to the reclose film 200 to separate a portion of the reclose film 200 from the substrate 250.

Referring to FIG. 4B, the reclose functionality of the reclose film 200 may be activated by applying an initial opening force F1 on the reclose film 200. The initial opening force F1 may be applied in a direction generally perpendicular to the film top facial surface 202 of the reclose film 200. The initial opening force F1 may be greater than a threshold force, at which separation of the reclose film 200 occurs to activate the reclose functionality. The initial opening force F1 may be sufficient to cause Layer A to fail at an interface 260 between the sealed region 254 and the unsealed region 256 of the reclose film 200. In some embodiments, the initial opening force F1 for the reclose film 200 may be less than or equal to about 40 newtons/inch (N/in), less than less than or equal to 37 N/inch, less than or equal to 35 N/inch, or even less than or equal to 30 N/inch after being heat sealed at a heat sealing temperature of 150° C. The initial opening force F1 may be determined according to the Peel Adhesion Test as described herein. The initial opening force F1 of the multilayer film may be determined according to the test method for peel strength described herein at the heat sealing temperature of 130° C. In some embodiments, the initial opening force F1 for the reclose film 200 may be from 25 N/inch to 40 N/inch, from 25 N/inch to 37 N/inch, from 25 N/inch to 35 N/inch, from 27 N/inch to 40 N/inch, from 27 N/inch to 37 N/inch, from 27 N/inch to 35 N/inch, from 30 N/inch to 40 N/inch, from 30 N/inch to 37 N/inch, or from 30 N/inch to 35 N/inch after the multilayer film is heat sealed at a heat sealing temperature of 130° C.

At an initial opening force F1 greater than the threshold force, Layer A ruptures at an interface 260 of the sealed region 254 and the unsealed region 256. Layer A may rupture in a direction from the bottom facial surface 214 to the top facial surface 212 of Layer A (e.g., generally perpendicular to the film top facial surface 202 or in the +/−Z direction of the coordinate axis of FIG. 4B). The internal cohesion strength of the composition of Layer B is less than the initial opening force and less than the bond strengths between the top facial surface 222 of Layer B and the bottom facial surface 214 of Layer A, and between the bottom facial surface 224 of Layer B and the top facial surface 232 of Layer C. Thus, once Layer A ruptures at the interface 260 of the sealed region 254 and the unsealed region 256, Layer B in the sealed region 254 cohesively fails in a direction generally parallel to the film top facial surface 202. Cohesive failure of Layer A results in a first portion 262 of the composition of Layer B coupled to the bottom facial surface 214 of Layer A and a second portion 264 of the composition of Layer B coupled to the top facial surface 232 of Layer C. Thus, in the opened portion of the sealed region 254, the composition of Layer B covers both the top facial surface 232 of Layer C and the bottom facial surface 214 of Layer A. The portion of Layer A in the sealed region 254, including the opened portion of the sealed region 254, remains sealed to the substrate 250 (i.e., the top facial surface 212 of Layer A remains sealed to the surface 252 of the substrate 250 in the sealed region 254, including the opened portion).

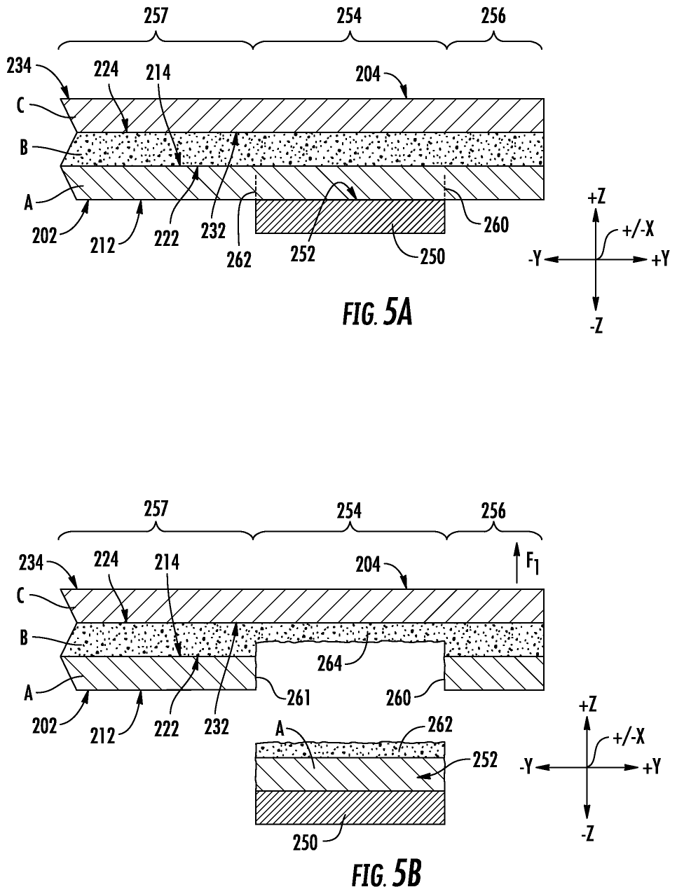

Referring to FIG. 5A, a cross-section of the reclose film 200 and substrate 250 of FIG. 4A is taken along reference line 5A-5A. In the embodiments schematically represented in FIG. 4A, the sealed region 254 may bounded by the unsealed region 256 on one side of the sealed region 254 and a second unsealed region 257 on the other side of the sealed region. During initial opening, the initial opening force F1 may cause Layer A to rupture at the interface 260 of the sealed region 254 and the unsealed region 256 in a direction generally perpendicular to the film top facial surface 202, as previously described in relation to FIG. 4B. As shown in FIG. 5B, the opening force F1 may cause Layer B to cohesively fail in a direction generally parallel to the film top facial surface 202, as previously described. When cohesive failure of Layer B reaches a second interface 261 between the sealed region 254 and the second unsealed region 257, the initial opening force F1 may cause Layer A to rupture again at the second interface 261 between the sealed region 254 and the second unsealed region 257. At the second interface 261, Layer A may rupture in a direction generally perpendicular to the film top facial surface 202. After initial opening of the reclose film 200, a portion of Layer A corresponding to the sealed region 254 is separated from the reclose film 200 and remains coupled to the substrate 250.

Initial opening of the reclose film 200 activates the reclose functionality of the multilayer film resulting in the first portion 262 of the composition of Layer B on the bottom facial surface 214 of Layer A and the second portion 264 of the composition of Layer B on the top facial surface 232 of Layer C. Referring to FIG. 4C, to reclose the sealed region 254 of the reclose film 200, the first portion 262 of the composition of Layer B may be returned into contact with the second portion 264 of the composition of Layer B and a reclose pressure F2 may be applied to the reclose film 200 in the sealed region 254. The reclose pressure F2 may be applied to the reclose film 200 in a direction generally perpendicular to the film bottom facial surface 204. The reclose pressure F2 may be sufficient to cause the first portion 262 and the second portion 264 of the composition of Layer B to re-adhere to reform Layer B. In some embodiments, the reclose pressure F2 may be less than or equal to 40 N/inch, less than or equal to 30 N/inch, less than or equal to 20 N/inch, or even less than or equal to 10 N/inch.

Applying the reclose pressure F2 to the multilayer film causes the first portion 262 and the second portion 264 of the composition of Layer B to re-adhere. Re-adherence of the first portion 262 and the second portion 264 of the composition to form a contiguous Layer B, may reseal the sealed region 254 of the multilayer film.

Referring to FIG. 4D, after reclosing the reclose film 200, the reclose film 200 may be reopened by applying a reopen force F3 to the reclose film 200. Reopen force F3 may be applied to the multilayer film in a direction generally perpendicular to the film top facial surface 202. The reopen force F3 may be applied by gripping the reclose film 200 in the unsealed region 256 and pulling the reclose film 200 away from the substrate 250. Application of the reopen force F3 may cause the composition of Layer B to cohesively fail in a direction parallel to the film top facial surface 102. Again, cohesive failure of the composition of Layer B results in a first portion of the composition coupled to the bottom facial surface 214 of Layer A and a second portion of the composition coupled to the top facial surface 232 of Layer C.

The reopen force F3 may be sufficient to cause the composition of Layer B to cohesively fail. In some embodiments reopen force F3 may be greater than or equal to 1 N/inch, greater than or equal to 1.5 N/inch, greater than or equal to 2.0 N/inch, greater than or equal to 2.5 N/inch, or even greater than or equal to 3 N/inch for the reclose film 200 heat sealed to the substrate 250 at a heat seal temperature of 130° C. The reopen force F3 may be determined according to the Peel Adhesion Test described herein. The reclose film 200 may be subjected to multiple cycles of reopening and reclosing. After multiple reopen/reclose cycles, the reclose film 200 may exhibit a reopen force F3 of greater than or equal to 1.5 N/inch, greater than or equal to 2.0 N/inch, greater than or equal to 2.5 N/inch, or even greater than 3.0 N/inch. For example, in some embodiments, the reclose film 200, which is initially heat sealed to the substrate 250 at a heat seal temperature of 130° C., may exhibit a reopen force F3 after at least four reopen/reclose cycles of greater than 2.0 N/inch. In some embodiments, the reclose film 200 may exhibit a reopen force of from 2.0 N/inch to 10.0 N/inch, from 2.0 N/inch to 7.0 N/inch, from 2.0 N/inch to 5.0 N/inch, from 2.5 N/inch to 10.0 N/inch, from 2.5 N/inch to 7.0 N/inch, or from 2.5 N/inch to 5.0 N/inch after being heat sealed at a heat seal temperature of 130° C., initially opened, and after experiencing at least 4 reclose-reopen cycles.

Referring to FIG. 5A, a cross-section of the reclose film 200 and substrate 250 of FIG. 4A is taken along reference line 5A-5A. In the embodiments schematically represented in FIG. 5A, the sealed region 254 may be bounded by the unsealed region 256 on one side of the sealed region 254 and a second unsealed region 257 on the other side of the sealed region. During initial opening, the initial opening force F1 may cause Layer A to rupture at the interface 260 of the sealed region 254 and the unsealed region 256 in a direction generally perpendicular to the film top facial surface 202, as previously described in relation to FIG. 4B. As shown in FIG. 5B, the opening force F1 may cause Layer B to cohesively fail in a direction generally parallel to the film top facial surface 202, as previously described. When cohesive failure of Layer B reaches a second interface 261 between the sealed region 254 and the second unsealed region 257, the initial opening force F1 may cause Layer A to rupture again at the second interface 261 between the sealed region 254 and the second unsealed region 257. At the second interface 261, Layer A may rupture in a direction generally perpendicular to the film top facial surface 202. After initial opening of the reclose film 200, a portion of Layer A corresponding to the sealed region 254 is separated from the reclose film 200 and remains coupled to the substrate 250.

Initial opening of the reclose film 200 activates the reclose functionality of the multilayer film resulting in the first portion 262 of the adhesive composition of Layer B on the bottom facial surface 214 of Layer A and the second portion 264 of the adhesive composition of Layer B on the top facial surface 232 of Layer C. Referring to FIG. 4C, to reclose the sealed region 254 of the reclose film 200, the first portion 262 of the adhesive composition of Layer B may be returned into contact with the second portion 264 of the adhesive composition of Layer B and a reclose pressure F2 may be applied to the reclose film 200 in the sealed region 254. The reclose pressure F2 may be applied to the reclose film 200 in a direction generally perpendicular to the film bottom facial surface 204. The reclose pressure F2 may be sufficient to cause the first portion 262 and the second portion 264 of the adhesive composition of Layer B to re-adhere to reform Layer B. In some embodiments, the reclose pressure F2 may be less than or equal to 40 N/inch, less than or equal to 30 N/inch, less than or equal to 20 N/inch, or even less than or equal to 10 N/inch.

Applying the reclose pressure F2 to the multilayer film causes the first portion 262 and the second portion 264 of the adhesive composition of Layer B to re-adhere. Re-adherence of the adhesive composition to form a contiguous Layer B reseals the sealed region 254 of the multilayer film. In some embodiments, the reclosing the reclose film 200 may result in a hermetic seal in the sealed region 254 of the reclose film 200.

Referring to FIG. 4D, after reclosing the reclose film 200, the reclose film 200 may be reopened by applying a reopen force F3 to the reclose film 200. Reopen force F3 may be applied to the multilayer film in a direction generally perpendicular to the film top facial surface 202. The reopen force F3 may be applied by gripping the reclose film 200 in the unsealed region 256 and pulling the reclose film 200 away from the substrate 250. Application of the reopen force F3 may cause the adhesive composition of Layer B to cohesively fail in a direction parallel to the film top facial surface 202. Again, cohesive failure of the adhesive composition of Layer B results in a first portion of the adhesive composition coupled to the bottom facial surface 214 of Layer A and a second portion of the adhesive composition couple to the top facial surface 232 of Layer C.

The reopen force F3 may be sufficient to cause the adhesive composition of Layer B to cohesively fail. In some embodiments reopen force F3 may be greater than or equal to 1 N/inch, greater than or equal to 1.5N/inch, greater than or equal to 2.0 N/inch, greater than or equal to 2.5 N/inch, or even greater than or equal to 3.0N/inch for the reclose film 200 heat sealed to the substrate 250 at a heat seal temperature of 130° C. The reopen force F3 may be determined according to the Peel Adhesion Test as described herein. The reclose film 200 may be subjected to multiple cycles of reopening and reclosing. After multiple reopen and reclose cycles, the reclose film 200 may exhibit a reopen force F3 of greater than or equal to 1.5 N/inch, greater than or equal to 2.0 N/inch, greater than or equal to 2.5 N/inch, or even greater than or equal to 3.0 N/inch. For example, in some embodiments, the reclose film 200, which is initially heat sealed to the substrate 250 at a heat seal temperature of 130° C., may exhibit a reopen force F3 after at least four reopen and reclose cycles of greater than 2.0 N/inch. In some embodiments, the reclose film 200 may exhibit a reopen force of from 2.0 N/inch, to 10.0 N/inch, from 2.0 N/inch to 7.0 N/inch, from 2.0 N/inch to 5.0 N/inch, from 2.5 N/inch to 10.0 N/inch, from 2.5 N/inch to 7.0 N/inch, or from 2.5 N/inch to 5.0 N/inch after being heat sealed, initially opened, and after undergoing at least 4 reclose and reopen cycles.

Referring again to FIGS. 1A, 1B, and 2, in one or more embodiments, the rear wall 120 of the reclosable package 100 may include the reclose film. In these embodiments, the interior surface 122 of the rear wall 120 may comprise the top facial surface 212 of Layer A. Further, the exterior surface 124 of the rear wall 120 may comprise the bottom facial surface 234 of Layer C. Layer B is disposed between Layer A and Layer C with a top facial surface 222 of Layer B in adhering contact with a bottom facial surface 214 of Layer A and a top facial surface 232 of Layer C is in adhering contact with the bottom facial surface 224 of Layer B. In such embodiments, the top facial surface 212 of Layer A may be sealed to the exterior surface 112 of the front wall 110. In one or more embodiments, the application of a force greater than the first adhesion strength to the rear wall 120 in a direction away from the front wall 110 is operable to cause the cohesive failure of Layer B, separating a portion of the interior surface 122 of the rear wall 120 from the exterior surface 112 of the front wall 110.

In one or more embodiments, the rear wall 120 of a reclosable package 100 may comprise the reclose film, and the exterior surface 124 of the rear wall 120 may comprise the top facial surface 212 of Layer A. Further, the interior surface 122 of the rear wall 120 may comprise a bottom facial surface 234 of Layer C. Layer B is disposed between Layer A and Layer C with a top facial surface 222 of Layer B in adhering contact with a bottom facial surface 214 of Layer A and a top facial surface 232 of Layer C is in adhering contact with the bottom facial surface 224 of Layer B. In such embodiments, the top facial surface 212 of Layer A may be sealed to the exterior surface 112 of the front wall 110. In one or more embodiments, the application of a force greater than the first adhesion strength to the rear wall 120 in a direction away from the front wall 110 is operable to cause the cohesive failure of Layer B, separating a portion of the interior surface 122 of the rear wall 120 from the exterior surface 112 of the front wall 110 to expose the reclose region 160.

In one or more embodiments, the front wall 110 of the reclosable package 100 may comprise the reclose film. In such embodiments, the exterior surface 112 of the front wall 110 may comprise the top facial surface 212 of Layer A. Further, the interior surface of the front wall 110 may comprise a bottom facial surface 234 of Layer C. Layer B is disposed between Layer A and Layer C with a top facial surface 222 of Layer B in adhering contact with a bottom facial surface 214 of Layer A and a top facial surface 232 of Layer C is in adhering contact with the bottom facial surface 224 of Layer B. In one or more embodiments, Layer A may be in adhering contact with the interior surface 122 of the rear wall 120. In one or more embodiments, the application of a force greater than the first adhesion strength to the rear wall 120 in a direction away from the front wall 110 is operable to cause the cohesive failure of Layer B, separating a portion of the interior surface 122 of the rear wall 120 from the exterior surface 112 of the front wall 110 to expose the reclose region 160.

In one or more embodiments, both the front wall 110 and the rear wall 120 of the reclosable package 100 may include the reclose film. In such embodiments, the exterior surface 112 of the front wall 110 may comprise the top facial surface 212 of Layer A₁. Further, the interior surface of the front wall 110 may comprise a bottom facial surface 234 of Layer C₁. Layer B₁ is disposed between Layer A₁ and Layer C₁ with a top facial surface 222 of Layer B₁ in adhering contact with a bottom facial surface 214 of Layer A₁ and a top facial surface 232 of Layer C₁ is in adhering contact with the bottom facial surface 224 of Layer B₁. In one or more embodiments, the front wall 110 of the reclosable package 100 comprises a reclose film. In such embodiments, the exterior surface 112 of the front wall 110 may comprise the top facial surface 212 of Layer A₂. Further, the interior surface of the front wall 110 may comprise a bottom facial surface 234 of Layer C₂. Layer B₂ is disposed between Layer A₂ and Layer C₂ with a top facial surface 222 of Layer B₂ in adhering contact with a bottom facial surface 214 of Layer A₂ and a top facial surface 232 of Layer C₂ is in adhering contact with the bottom facial surface 224 of Layer B₂. In one or more embodiments, Layer A₁ may be in adhering contact with Layer A₂. In one or more embodiments, the application of a force greater than the first adhesion strength to the rear wall 120 in a direction away from the front wall 110 is operable to cause the cohesive failure of either Layer Bᵢ or Layer B₂, separating a portion of the interior surface 122 of the rear wall 120 from the exterior surface 112 of the front wall 110, thereby exposing the reclose region 160.

In one or more embodiments, the upper closure 130 may include a reclose film disposed between the interior surface 122 of the rear wall 120 and the exterior surface 112 of the front wall 110. In such embodiments, both the Layer A and the Layer C may be sealant layers. A top facial surface 212 of the Layer A may be in adhering contact with the interior surface 122 of the rear wall 120 and a bottom facial surface 234 of Layer C may be in adhering contact with the exterior surface 112 of the front wall 110. Layer B is disposed between Layer A and Layer C with a top facial surface 222 of Layer B in adhering contact with a bottom facial surface 214 of Layer A and a top facial surface 232 of Layer C is in adhering contact with the bottom facial surface 224 of Layer B. In one or more embodiments, the application of a force greater than the first adhesion strength to the rear wall 120 in a direction away from the front wall 110 is operable to cause the cohesive failure of Layer B, separating a portion of the interior surface 122 of the rear wall 120 from the exterior surface 112 of the front wall 110, thereby exposing the reclose region 160.

In one or more embodiments where the front wall 110, the rear wall 120, or both comprise a reclose film, the application of a force greater than the first adhesion strength to the rear wall 120 in a direction away from the front wall 110 is operable to cause the cohesive failure of Layer B, separating a portion of a surface of the rear wall 120 from the exterior surface 112 of the front wall 110. In one or more embodiments, the cohesive failure of Layer B may result in the exposing of a reclose region 160 on the exterior surface 112 of the front wall 110 and a exposing a reclose region 160 on the surface of the rear wall 120. Each of the exposed reclose regions 160 may comprise at least part of the failed Layer B. In one or more embodiments, the return of a portion of the Layer B disposed on the surface of the rear wall 120 to the portion of Layer B disposed on the exterior surface 112 of the front wall 110 followed by the subsequent application of a force on the rear wall 120 in the direction of the front wall 110, proximate to the reclose regions 160, is operable to reseal the front wall 110 to the rear wall 120.

In one or more embodiments, the walls of the reclosable package comprise a flexible film. In some embodiments, the film may be formed by any conventional means known in the art including, but not limited to, blown film extrusion, cast film extrusion, or other extrusion techniques known in the art. In one or more embodiments, the forming of the film further utilizes coextrusion, a process in which multiple layers of material may be extruded simultaneously. In one or more coextrusion applications, multiple layers of different types of material may be extruded simultaneously. Techniques of coextrusion may be applied to any conventional methods known in the art including, but not limited to blown film extrusion or cast film extrusion. In one or more embodiments, after the film is formed, but before it is incorporated into a package, the film may be laminated. In other embodiments, the film is not laminated prior to the formation of the package.

FIGS. 1A-1B illustrate only a couple examples of reclosable package designs that can incorporate the reclosable film and compositions according to embodiments of the present disclosure. A person of ordinary skill in the art can readily identify other package types, shapes, and sizes in which the reclosable film and composition disclosed herein may be incorporated. For example, the reclosable film and/or compositions may be incorporated into package shapes and sizes for which zippers or other mechanical means have been used to provide reclosability to the package. Additionally, the reclosable films and compositions may be incorporated into a broad range of package types and shapes that include at least one flexible film. Examples of these packaging types may include, but are not limited to tray packaging; pouch packaging such as pillow pouches, vertical form fill and seal (VFFS) packaging, horizontal form fill and seal packages, stand-up pouches, or other pouches; bags; boxes; or other type of packaging. The reclosable films and compositions may be incorporated into primary packaging or secondary packaging, such as overwraps, bags, or other secondary packaging. Other packaging types, shapes and sizes having the reclosable film and/or compositions disclosed herein are also contemplated.

In some embodiments, the reclosable packaging disclosed herein may be used to package food products, beverages, consumer goods, personal care items, or other articles. Food products that may be packaged using the reclosable packaging disclosed herein may include particular food products, such as sugar, spices, flour, coffee, or other particulates; solid food products; such as meats, cheeses, snacks, vegetables, baked goods, pet food, pasta, or other solid food products; liquid food products, such as but not limited to milk, soup, beverages, or other liquid food products; and/or bulk food items such as but not limited to rice, dog food, flour or other grains, or other bulk food items. Consumer goods that may be packaged using the reclosable packaging may include but are not limited to consumer electronics, hardware, toys, sporting goods, plastic utensils, autoparts, batteries, cleaning supplies, software packages, salt, or other consumer goods. The reclosable packages disclosed herein may also be incorporated into post-consumer storage bags, such as food storage bags or freezer bags. A person of ordinary skill in the art can recognize many other potential uses for the reclosable packaging disclosed herein.

### EXAMPLES

The following Examples illustrate various embodiments of the composition and multilayer film described herein. The compositions of the following examples and comparative examples were compounded using a single stage twin-screw extrusion process. The compounding operation is performed on a Century-ZSK-40 45.375 length-to-diameter ratio (L/D) (Eleven Barrels) extruder using one screw design with one oil injector, in barrel 4. The extruder has a maximum screw speed of 1200 rpm. The polymers and the PICCOTAC tackifier were fed into the main feed throat of the extruder. The HYDROBRITE 550 process oil is added through an injection port at barrel 4. The compound is pelletized using an underwater Gala system, which is equipped with a 12 hole (2.362 mm hole diameter) Gala die with 6 holes plugged, and a 4 blade hub cutter. Soap and antifoam were added to the water bath as needed to prevent clumping. The pellets were collected and dusted with 2000 ppm POLYWAX 2000 (available from Baker Hughes), and then dried under nitrogen purge for 24 hours. Screw speed is set at 180 RPM for all the samples. Temperature profile is set as follows: 100° C. (zone 1), 100° C. (zone 2), 180° C. (zone 3), 180° C. (zone 4), 160° C. (zone 5), 160° C. (zone 6), 110° C. (zone 7), 110° C. (zone 8), 90° C. (zone 9), 90° C. (zone 10), and 90° C. (zone 11), with a die temperature of 140° C.

Table 1 below includes properties of commercial polymers used in the Examples that follow.

TABLE 1
Properties of commercial polymers

| | Melt Index | Density | |
|---|---|---|---|
| Material | (I₂) g/10 min | (g/cc) | Supplier |
| INFUSE ™ 9107 | 1.00 | 0.866 | The Dow Chemical |
| (olefin block | | | Company, Midland, |
| copolymer) | | | MI |
| DOW ™ LDPE | 4.20 | 0.924 | The Dow Chemical |
| 5004i (LDPE) | | | Company, Midland, |
| | | | MI |
| DOWLEX ™ NG | 1.00 | 0.935 | The Dow Chemical |
| 2038.68G (LLDPE) | | | Company, Midland, |
| | | | MI |
| ENGAGE ™ 8842 | 1.00 | 0.857 | The Dow Chemical |
| (polyolefin | | | Company, Midland, |
| plastomer) | | | MI |
| VECTOR ® 4113A | 9.20 | 0.920 | Dexco Polymers, |
| (styrene-isoprene | | | Houston, TX |
| triblock copolymer) | | | |
| VECTOR ® 4213A | 12.0 | 0.940 | Dexco Polymers, |
| (SIS triblock/SI | | | Houston, TX |
| diblock copolymer) | | | |
| ELVAX ® 3124 | 7.0 | 0.930 | E.I. du Pont de |
| (ethylene-vinyl | | | Nemours and |
| acetate copolymer | | | Company, Inc. |
| w/9 wt. % | | | |
| vinyl acetate) | | | |

### Example 1: Example Composition

A composition according to the present disclosure was made by combining 43.4 wt. % ethylene/α-olefin random copolymer, 20 wt. % styrenic block copolymer, 30 wt. % tackifier, and 6.6 wt. % mineral oil. The ethylene/α-olefin random copolymer was ENGAGE 8842. The styrenic block copolymer was VECTOR 4113A styrene-isoprene triblock copolymer, which had a styrene content of 18 wt. %, and a diblock content of 42 wt. %. The tackifier was PICCOTAC 1100 C₅ tackifier available from Eastman Chemical Company. The tackifier has a ring and ball softening point of 100° C. and a Mw of 2900. The mineral oil was HYDROBRITE 550 mineral oil available from Sonneborn and exhibited a density of 0.87 g/cm³ and paraffinic carbon content of about 70 wt. %.

The individual constituents of the composition of Example 1 were compounded according to the previously described single stage twin-screw extrusion process. The composition of Example 1 was then tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Example 1 are provided below in Table 2.

### Comparative Example 2: Comparative Adhesive Composition Formulated with Olefin Block Copolymer

In Comparative Example 2, a comparative adhesive composition was produced using an olefin block copolymer in place of the ethylene/α-olefin random copolymer of Example 1. The composition of Comparative Example 2 included 43.4 wt. % olefin block copolymer, 20 wt. % of the styrenic block copolymer, 30 wt. % tackifier, and 6.6 wt. % mineral oil. The olefin block copolymer was INFUSE™. The styrenic block copolymer, tackifier, and mineral oil in Comparative Example 2 were the same as described above for Example 1.

The individual constituents of Comparative Example 2 were compounded using the previously described single stage twin-screw extrusion process. The composition of Comparative Example 2 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 2 are provided below in Table 2.

### Comparative Example 3: Comparative Adhesive Composition Formulated with a Lesser Amount of Olefin Block Copolymer

In Comparative Example 3, a comparative adhesive composition was produced using an olefin block copolymer in place of the ethylene/α-olefin random copolymer of Example 1. The composition of Comparative Example 3 included less olefin block copolymer and more styrenic block copolymer compared to the composition of Comparative Example 2. Comparative Example 3 was prepared to investigate the effect of increasing the amount of the styrenic block copolymer in the adhesive composition.

The composition of Comparative Example 3 included 33.4 wt. % olefin block copolymer, 30 wt. % of the styrenic block copolymer, 30 wt. % tackifier, and 6.6 wt. % mineral oil. The olefin block copolymer was INFUSE 9107. The styrenic block copolymer, tackifier, and mineral oil were the same as described above for Example 1.

The individual constituents of Comparative Example 3 were compounded using the previously described single stage twin-screw extrusion process. The composition of Comparative Example 3 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 3 are provided below in Table 2.

### Comparative Example 4: Commercially Available Adhesive Composition for Reclose Multilayer Films

For Comparative Example 4, a commercially available pressure sensitive adhesive composition marketed as providing reclose capability to multilayer film compositions was obtained. The commercially available composition comprised a styrene-isoprene-styrene block copolymer, hydrocarbon tackifier, and talc. The commercially available composition did not include a polyethylene component, such as a polyethylene/α-olefin copolymer. The commercially available adhesive composition was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 4 are provided below in Table 2.

### Comparative Example 5: Comparative Adhesive Composition Formulated with Styrenic Block Copolymer, Tackifier, and Oil

In Comparative Example 5, a comparative adhesive composition was produced using a styrenic block copolymer without the ethylene/α-olefin random copolymer of Example 1. The composition of Comparative Example 5 included 64.3 wt. % styrenic block copolymer, 30 wt. % tackifier, and 6.6 wt. % mineral oil. The styrenic block copolymer was VECTOR® 4213A SIS triblock/SI diblock copolymer. The tackifier and mineral oil were the same as described above for Example 1.

The individual constituents of Comparative Example 5 were compounded using the previously described single stage twin-screw extrusion process. The composition of Comparative Example 5 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 5 are provided below in Table 2.

### Comparative Example 6: Comparative Adhesive Composition Formulated with EVA and Styrenic Block Copolymer

In Comparative Example 6, a comparative adhesive composition was produced using an ethylene-vinyl acetate copolymer (EVA) in place of the ethylene/α-olefin random copolymer of Example 1. The composition of Comparative Example 6 included 20.0 wt. % EVA, 43.4 wt. % styrenic block copolymer, 30 wt. % tackifier, and 6.6 wt. % mineral oil. The EVA was ELVAX® ethylene-vinyl acetate copolymer having 9 wt. % vinyl acetate. The styrenic block copolymer, tackifier, and mineral oil were the same as described above for Example 1.

The individual constituents of Comparative Example 6 were compounded using the previously described single stage twin-screw extrusion process. The composition of Comparative Example 6 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 6 are provided below in Table 2.

### Example 7: Comparison of Properties of the Compositions of Example 1 and Comparative Examples 2-6

Table 2, which is provided below, includes the density, melt index (I₂), and melt flow rate for the composition of Example 1 and the adhesive compositions of Comparative Examples 2-6.

TABLE 2
Properties of the composition of Example 1 compared to the properties
of the adhesive compositions of Comparative Examples 2-4

| | Density | Melt Index (I2) | MFR |
|---|---|---|---|
| Example | (g/cm³) | (g/10 min) | (230° C./2.16 kg) |
| Ex. 1 | 0.904 | 10.0 | 32.5 |
| Comp. Ex. 2 | 0.907 | 8.6 | 26.3 |
| Comp. Ex. 3 | 0.913 | 13.8 | 53.7 |
| Comp. Ex. 4 | >0.920 | 56.5 | N/A |
| Comp. Ex. 5 | 0.942 | 20.4 | 127.6 |
| Comp. Ex. 6 | 0.933 | 44.1 | 151.1 |

The composition of Example 1 and the adhesive compositions of Comparative Examples 2, 3, 5, and 6 were additionally tested using DSC to determine the melting curves of the compositions, from which the crystallization temperatures (Tc ° C.), melt temperature (Tm ° C.), glass transition temperature (Tg ° C.), heat of crystallization (ΔHc joules/gram (J/g)), and heat of melting (ΔHm J/g) for each composition, in accordance with the testing procedure previously described herein. These properties are provided below in Table 3. The composition of Example 1 and the adhesive compositions of Comparative Examples 2, 3, 5, and 6 were additionally testing using DMS to determine the dynamic melt viscosity (η* millipascal seconds (mPa-s)) at 150° C., the ratio of the dynamic melt viscosity at 0.1 radians per second to the dynamic melt viscosity at 100 radians per second at a temperature of 150° C. (η* ratio at 150° C.), and the storage modulus (G′@ 25° C. dyne/cm²) for each composition, according to the DMS testing procedure previously described herein. The results of the DMS testing are provided below in Table 3. The composition of Example 1 was tested two times, and the results reported in Table 3 below as Ex. 1-A and 1-B.

TABLE 3
Melt temperature, crystallization temperature, dynamic melt viscosity, and storage
modulus data for the compositions of Example 1 and Comparative Examples 2-6

| | Ex. 1-A | Ex. 1-B | Comp. 2 | Comp. 3 | Comp. 5 | Comp. 6 |
|---|---|---|---|---|---|---|
| T_{c1} (° C.) | 16.5 | 17.2 | 101.6 | 101.5 | — | 78.8 |
| T_{c2} (° C.) | — | — | — | — | — | 52.1 |
| ΔH_{c} (J/g) | 16.3 | 14.9 | 22.0 | 19.5 | — | 17.0 |
| T_{g} (° C.) | −54.55 | −53.7 | −52.2 | −53.1 | −54.7 | −52.0 |
| Tₘ₁ (° C.) | 42.2 | 43.2 | 119.3 | 119.0 | — | 93.0 |
| ΔHₘ (J/g) | 16.9 | 18.1 | 18.6 | 16.4 | — | — |
| η* (mPa · s) | 4.0 × 10⁶ | 3.3 × 10⁶ | 3.3 × 10⁶ | 3.1 × 10⁶ | 7.9 × 10⁶ | 2.0 × 10⁶ |
| 150° C. | | | | | | |
| η* ratio at | 8.9 | 7.7 | 17.5 | 17.0 | 64.9 | 11.8 |
| 150° C. | | | | | | |

As shown in Table 3 above, the composition of Examples 1-A and 1-B exhibited a lower crystallization temperature and melt temperature profile compared to the adhesive compositions of Comparative Examples 2, 3, 5, and 6. Without being bound by theory, it is believed that lower crystallization and melting temperatures may reduce or prevent secondary crystallization of the constituents of the composition, which increases the cohesive strength of the composition. Increased cohesive strength may provide lower opening force for the composition and more tackiness, which increases the reclose force. Thus, the lower crystallization and melting temperatures of the composition of Example 1 (Ex. 1-A, 1-B) may reduce or prevent secondary crystallization of the composition, thereby increasing the cohesive strength of the composition compared to the compositions of Comparative Examples 2, 3, 5, and 6. The lower crystallization and melting temperatures of the composition of Example 1 enables the composition of Example 1 to exhibit a greater reclose force compared to the compositions of Comparative Examples 2, 3, 5, and 6.

Additionally, the dynamic melt viscosity ratio (11* ratio) at 150° C. for the composition of Examples 1-A and 1-B were less than the dynamic melt viscosity ratios of Comparative Examples 2, 3, 5, and 6. Without being bound by theory, it is believed that a lower dynamic melt viscosity ratio translates to more consistent behavior in response to different shear rates, such as the different shear rates experienced by the film layer during film fabrication (e.g., blown film extrusion) or sealing conditions. The compositions of Comparative Examples 2, 3, 5, and 6 have greater dynamic melt viscosity ratios, and therefore it is expected to be harder to maintain a stable bubble during blown film extrusion if shear rate changes. Additionally, the adhesive layer made from the compositions of Comparative Examples 2, 3, 5, and 6 could thin out to a greater extent with increases in sealing pressure, which would reduce the thickness of the adhesive layer and reduce the amount of adhesive composition to enable cohesive peeling through the adhesive and packaging resealing. The composition of Examples 1-A and 1-B, which exhibited a reduced dynamic melt viscosity ratio of the compared to the compositions of Comparative Examples 2, 3, 5, and 6, is less sensitive to changes in shear rates, and therefore, the compositions of Examples 1-A and 1-B may be easier to process into the multilayer film and provide more consistent performance over a range of sealing temperatures and pressures compared to the compositions of Comparative Examples 2, 3, 5, and 6.

### Example 8: Multilayer Films with the Compositions of Example 1 and Comparative Examples 2-4

In Example 8, each of the composition of Example 1 and adhesive compositions of Comparative Examples 2 and 3 were used to make a multilayer film to evaluate the reclose properties of the compositions. The multilayer films were five-layer films made using blown film extrusion and included Layer A, Layer B, Layer C, Layer D, and Layer E. Layer A was a seal layer comprising 98.4 wt. % DOW LDPE 5004i, 1.0 wt. % AMPACET 10063 antiblock masterbatch available from Ampacet Corporation, and 0.6 wt. % AMPACET 10090 slip masterbatch available from Ampacet Corporation. Layer B included the composition of Example 1 or one of the adhesive compositions of Comparative Examples 2-4. Layers C, D, and E all included identical layers of 100 wt. % DOWLEX 2038.68G LLDPE. The formulations for each multilayer film of Example 8 are provided below in Table 4.

TABLE 4
Multilayer film formulations for Example 8

| Ex. | Ex. 8A | Comp. 8B | Comp. 8C |
|---|---|---|---|
| Thickness (mil) | 3 | 3 | 3 |
| Layer A | LDPE 5004i | LDPE 5004i | LDPE 5004i |
| Layer B | Ex. 1 | Comp. 2 | Comp. 3 |
| Layer C | DOWLEX | DOWLEX | DOWLEX |
| | 2038.68G | 2038.68G | 2038.68G |
| Layer D | DOWLEX | DOWLEX | DOWLEX |
| | 2038.68G | 2038.68G | 2038.68G |
| Layer E | DOWLEX | DOWLEX | DOWLEX |
| | 2038.68G | 2038.68G | 2038.68G |
| Layer ratio (%) | 10/20/20/20/30 | 10/20/20/20/30 | 10/20/20/20/30 |

The blown film extrusion samples were fabricated using a LABTECH 5-layer blown film line, and each layer was formed at the same temperature of 190° C. The heat seal layer was positioned on the outside of the bubble, and the material was self-wound on uptake rollers. Film fabrication conditions for films 6A-6C are shown in Table 5.

TABLE 5
Blown film fabrication conditions for making
the multilayer films of Example 8

| Film ID | 6A | 6B | 6C |
|---|---|---|---|
| Output (kg/hr) | 30-35 | 17.3 | 17.3 |
| Gauge (micron) | 70 | 76.2 | 76.2 |
| Layflat (cm) | 31.75 | 33.0 | 33.0 |
| Line speed (m/min) | <1.5 | 5.0 | 5.0 |

Melt temperature (° C.)

| | | | |
|---|---|---|---|
| Extruder 1 | 215° C. | 207 | 207 |
| Extruder 2 | 190° C. | 152 | 152 |
| Extruder 3 | 220° C. | 218 | 218 |
| Extruder 4 | 220° C. | 214 | 214 |
| Extruder 5 | 220° C. | 211 | 211 |

Melt pressure (megapascals)

| | | | |
|---|---|---|---|
| Extruder 1 | <5500 | 6 | 6 |
| Extruder 2 | <5500 | 7 | 7 |
| Extruder 3 | <5500 | 23 | 23 |
| Extruder 4 | <5500 | 31 | 31 |
| Extruder 5 | <5500 | 21 | 21 |

The multilayer films of Example 8 and shown in Tables 4 and 5 are of good integrity. These multilayer films of Example 8 are flexible films, formed from only coextrudable polymer formulations. These multilayer films can be used for packaging products, and can be processed on conventional film converting equipment.

A fourth film, comparative film 8D, was obtained and evaluated. Comparative film 8D was a commercially-available multilayer film believed to have been made by a blown film process at conditions typical in the blown film industry. The film 8D included a pressure sensitive adhesive layer that was found to include primarily an SIS block copolymer. The film 8D was found to not include a polyethylene copolymer of any kind.

Each of the multilayer film 8A, and comparative films 8B, 8C, and 8D of Example 8 were adhesively laminated to a 48 gauge biaxially oriented polyethylene terephthalate (PET) (available from DuPont Teijin) using MORFREE 403A (solventless adhesive) and co-reactant C411 (solvent-less adhesive) both of which are available from the Dow Chemical Company, Midland Mich., to form a final laminate film structure (sealant/PSA/core (3 layers)/solventless adhesive/PET). The multilayer films of Example 8 were tested for initial peel strength and reclose peel strength according to the peel adhesion test previously described herein. The reclose peel strength for each film was measured at time intervals after the initial opening peel strength. The result for the initial peel strength and subsequent reclose peel strengths for each of film 8A, and comparative films 8B, 8C, and 8D are provided below in table 6. The peel strength measurements are in units of newtons per inch (N/in) in Table 6 below.

TABLE 6
Initial peel adhesion and reclose peel adhesion for the multilayer films of Example 8

| | Initial | |
|---|---|---|
| Film ID/ | Peel | |
| Seal Temp | Strength | Reopen Peel Strength (N/in) |

| (° C.) | Layer B | (N/in) | 20 | 20 | 20 | 20 | 30 | 20 | 60 | 20 |
|---|---|---|---|---|---|---|---|---|---|---|
| Film 6A | Ex. 1 | Time = 0 | min | min | min | min | min | min | min | min |
| 130 | Ex. 1 | 34.7 | 5.7 | 3.7 | 2.9 | 2.8 | 2.5 | NA | 2.3 | 2.2 |
| 150 | Ex. 1 | 40.5 | 7.7 | 4.7 | 3.9 | 3.1 | 3.1 | NA | 2.7 | 2.4 |

| | | | 20 | 20 | 20 | 20 | 30 | 20 | 60 | 20 |
|---|---|---|---|---|---|---|---|---|---|---|
| Comp. 6B | Comp. 2 | Time = 0 | min | min | min | min | min | min | min | min |
| 130 | Comp. 2 | 43.8 | 6.6 | 4.4 | 3.7 | 3.2 | 2.9 | NA | 2.5 | 2.1 |
| 150 | Comp. 2 | 44.5 | 6.9 | 5.5 | 4.6 | 4.0 | 3.3 | NA | 2.6 | 2.4 |
| | | | 20 | 20 | 20 | 20 | 20 | 50 | 20 | 20 |
| Comp. 6C | Comp. 3 | Time = 0 | min | min | min | min | min | min | min | min |
| 130 | Comp. 3 | 27.7 | 4.6 | 3.8 | 3.3 | 2.5 | 2.2 | 2.4 | 2.1 | 1.9 |
| 140 | Comp. 3 | 29.0 | 3.9 | 2.9 | 2.0 | 1.8 | 1.8 | 1.4 | 1.4 | 1.3 |
| 150 | Comp. 3 | 30.6 | 3.2 | 2.0 | 1.5 | 1.1 | 1.0 | 1.0 | 0.9 | 0.8 |
| | | | 20 | 20 | 20 | 20 | 20 | 50 | 20 | 20 |
| Comp. 6D | Comp. 4 | Time = 0 | min | min | min | min | min | min | min | min |
| 140 | Comp. 4 | 22.6 | 0.3 | 0.2 | 0.1 | 0.1 | 0.1 | 0.1 | 0.1 | 0.1 |
| 150 | Comp. 4 | 18.7 | 1.2 | 0.6 | 0.4 | 0.1 | 0.1 | 0.3 | 0.1 | 0.0 |

As shown in Table 6 above, film 8A, which included the composition of Example 1, exhibited an initial peel strength 34.7 N/in at a heat seal temperature of 130° C. After being heat sealed at a temperature of 130° C. and initially opened, film 8A exhibited a reclose peel adhesion of at least 2.5 N/in through four reclose cycles and a reclose peel adhesion of greater than 2.0 N/in after at least 7 reclose cycles. At a sealing temperature of 150° C., the initial peel adhesion strength of film 8A was 40.5 N/in and the reclose peel adhesion strength was greater than 3 N/in after four reclose cycles and greater than 2.0 after at least 7 reclose cycles.

Comparative film 8D, which was made with the adhesive composition of Comparative Example 4 that included mostly a styrene block copolymer, exhibited an initial peel strength 18.7 N/in at a heat seal temperature of 150° C. After being heat sealed at a temperature of 150° C. and initially opened, comparative film 8D exhibited a reclose peel adhesion of less than 1.0 N/in through four reclose cycles and negligible reclose peel adhesion of less than 0.1 N/in after at least 7 reclose cycles. Thus, at an initial sealing temperature of 150° C., initial peel strength of 40.5 N/in of the film 8A made with the composition of Example 1 was substantially higher than the initial peel strength of the comparative film 8D that included the styrene block copolymer pressure sensitive adhesive (PSA) of Comparative Example 4. Film 8A also exhibited a substantially greater reclose peel strength after 4 cycles and 7 cycles compared to the comparative film 8D that included the styrene block copolymer PSA of Comparative Example 4.

Comparative film 8B included the adhesive composition of Comparative Example 2 for Layer B. The adhesive composition of Comparative Example 2 included 43.4 wt. % of an ethylene/α-olefin block copolymer and 20 wt. % styrenic block copolymer. The film 8A included the composition of Example 1, which comprised 43.4 wt. % of the ethylene/α-olefin random copolymer. Thus, the difference in composition between the composition of Example 1 and the adhesive composition of Comparative Example 2 is the substitution of the ethylene/α-olefin random copolymer in Example 1 for the ethylene/α-olefin block copolymer used in Comparative Example 2. At a sealing temperature of 130° C., film 8A, which included the composition of Example 1, exhibited an initial peel strength of 34.7 N/inch. Comparative film 8B, which included the adhesive composition of Comparative Example 2, exhibited an initial peel strength of 43.8 N/inch. Thus, film 8A resulted in a lower initial peel strength compared to the initial peel strength of comparative film 8B. The reclose peel strength of film 8A after 4 cycles and after 7 cycles was comparable to the reclose peel strength of comparative film 8B that included the adhesive composition of Comparative Example 2. The results measured after heat sealing at 150° C. exhibited a similar comparative relationship to the films prepared at a heat sealing temperature of 130° C. These results for film 8A and comparative film 8B indicate that the film 8A requires a lesser initial opening force compared to comparative film 8B, but would provide equivalent reclose performance. Therefore, film 8A would be easier to initially open compared to comparative film 8B, but would provide equivalent reclose strength to comparative film 8B.

Comparative film 8C included the adhesive composition of Comparative Example 3, which included only 33.4 wt. % of the ethylene/α-olefin block copolymer and 30 wt. % styrenic block copolymer. Thus, Layer B of comparative film 8C had an increased proportion of styrenic block copolymer and decreased amount of ethylene/α-olefin block copolymer compared to Layer B of comparative film 8B and film 8A. As shown by the results in Table 6, increasing the amount of the styrenic block copolymer in Layer B reduces the initial peel strength of the comparative film 8C compared to the initial peel strength of film 8A. However, the increased amount of styrenic block copolymer in Layer B of comparative film 8C was observed to degrade the reclose peel strength performance of comparative film 8C compared to the reclose peel strength of film 8A. The degradation in the reclose peel strength performance of comparative film 8C is more pronounced after sealing comparative example 8C at the seal temperature of 150° C. Although increasing the amount of styrenic block copolymer in Layer B, such as with comparative film 8C, may decrease the initial peel strength and make the film easier to open, increasing the amount of the styrenic block copolymer in Layer B may adversely affect the reclose peel strength, resulting in weaker reclose seal strength and a reduction in the number of reclose cycles possible for the film. Thus, film 8A that included the composition of Example 1 in Layer B may provide better reclose performance compared to the comparative film 8C, which included an increased amount of styrenic block copolymer in Layer B.

Film 8A has a lesser amount of styrenic block copolymer in Layer B compared with comparative films 8C and 8D. Therefore, film 8A may provide reclose functionality to food packaging without impacting the odor and/or taste of the food products packaged therein.

1. A reclosable package comprising:
a front wall of the package;
a rear wall of the package; and
an upper closure at which at least a portion of a surface of the rear wall is sealed to an exterior surface of the front wall at a first adhesion strength;
wherein the application of a force greater than the first adhesion strength to the rear wall in a direction away from the front wall is operable to separate the portion of the surface of the rear wall from the exterior surface of the front wall to expose a reclose region on the exterior surface of the front wall; and
wherein the return of the portion of the surface of the rear wall into contact with the reclose region and application of a force on the rear wall in the direction of the reclose region is operable to reseal the portion of the surface of the rear wall to the exterior surface of the front wall at a second adhesion strength.

2. The reclosable package of claim 1, wherein the surface of the rear wall sealed to an exterior surface of the front wall is an interior surface.

3. The reclosable package of claim 1, wherein the surface of the rear wall sealed to an exterior surface of the front wall is an exterior surface.

4. The reclosable package of claim 1, wherein the rear wall comprises a tab extending from an edge of the rear wall proximate to the upper closure.

5. The reclosable package of claim 1, wherein after the resealing of the separated portion of the surface of the rear wall to the exterior surface of the front wall at a second adhesion strength, the application of a force greater than the second adhesion strength to the rear wall in a direction away from the front wall is operable to separate at least a portion of the surface of the rear wall from the exterior surface of the front wall.

6. The reclosable package of claim 1, wherein the first adhesion strength is less than or equal to 40 N/inch.

7. The reclosable package of claim 1, wherein the second adhesion strength is greater than or equal to 2.0 N/inch after at least four separating and resealing cycles.

8. The reclosable package of claim 1, wherein the upper closure comprises a reclose film.

9. The reclosable package of claim 1, wherein the rear wall comprises a reclose film.

10. The reclosable package of claim 1, wherein the upper closure comprises a strip of reclose film disposed between the surface of the rear wall and the exterior surface of the front wall.

11. The reclosable package of claim 1, wherein the upper closure comprises at least 3 layers and the at least 3 layers include:
a sealant layer comprising a top facial surface and a bottom facial surface;
a reclose layer, comprising a top facial surface, a bottom facial surface, and an adhesive;
at least one outer layer comprising a top facial surface;
wherein:
the reclose layer is disposed between the sealing layer and the at least one outer layer;
the top facial surface of the reclose layer is in adhering contact with the bottom facial surface of the sealant layer; and
the bottom facial surface of the reclose layer is in adhering contact with the top facial surface of the at least one outer layer.

12. The reclosable package of claim 11, wherein the sealant layer comprises either the front wall or the rear wall.

13. The reclosable package of claim 11, wherein the at least one outer layer comprises either the front wall or the rear wall.

14. The reclosable package of claim 11, wherein the adhesive comprises:
an ethylene/α-olefin random copolymer; and
a styrenic block copolymer comprising from greater than 1 wt. % to less than 50 wt. % units of polymerized styrene;
a tackifier; and
an oil.

15. The reclosable package of claim 11, wherein the adhesive comprises:
from 30 wt. % to 65 wt. % of the ethylene/α-olefin random copolymer;
from 10 wt. % to 35 wt. % of the styrenic block copolymer;
from 20 wt. % to 40 wt. % of a tackifier; and
from greater than 0 wt. % to 8 wt. % of an oil.
